(19) United States
(12) Patent Application Publication
(10) Pub. No.: US 2006/0285091 A1
(43) Pub. Date: Dec. 21, 2006

(54) Lithographic projection apparatus, gas purging method, device manufacturing method and purge gas supply system related application

(76) Inventors: Bipin S. Parekh, Chelmsford, MA (US); Robert S. Zeller, Boston, MA (US); Russell J. Holmes, Santee, CA (US); Jeffrey J. Spiegelman, San Diego, CA (US)

Correspondence Address: MYKROLIS CORPORATION, 129 CONCORD ROAD, BILLERICA, MA, 01821-4600, US

(21) Appl. No.: 11/396,823

(22) Filed: Apr. 3, 2006

Related U.S. Application Data
(63) Continuation-in-part of application No. 10/623,180, filed on Jul. 21, 2003.
(63) Continuation-in-part of application No. PCT/US04/23490, filed on Jul. 21, 2004.

(51) Int. Cl. G03B 27/52

(52) U.S. Cl. 355/30; 355/53

(57) ABSTRACT

A lithographic projection apparatus includes a support configured to support a patterning device, the patterning device configured to pattern a projection beam according to a desired pattern. The apparatus has a substrate table configured to hold a substrate, a projection system configured to project the patterned beam onto a target portion of the substrate. The apparatus also has a purge pas supply system configured to provide a purge gas near a surface of a component of the lithographic projection apparatus. The purge gas supply system includes a purge gas mixture generator configured to generate a purge gas mixture which includes at least one purging gas and moisture. The purge gas mixture generator has a moisturizer configured to add the moisture to the purge gas and a purge gas mixture outlet connected to the purge gas mixture generator configured to supply the purge gas mixture near the surface.

### CROSS REFERENCE TO RELATED APPLICATIONS

This application claims the benefit of and is a continuation-in-part of U.S. application Ser. No. 10/623,180, filed Jul. 21, 2003; this application claims the benefit of and is a continuation in part of International Patent Application No. PCT/US2004/023490, filed Jul. 21, 2004, the contents of these applications incorporated herein by reference in their entirety.

### BACKGROUND

Surfaces of components present in a lithographic projection apparatus can gradually become contaminated during use, even if most of the apparatus is operated in vacuum. In particular, the contamination of optical components in a lithographic projection apparatus, such as mirrors, has an adverse effect on the performance of the apparatus, because such contamination affects the optical properties of the optical components.

It is known that contamination of optical components of a lithographic projection apparatus can be reduced by purging a space of the lithographic projection apparatus in which such a component is located with an ultra high purity gas, referred to as a purge gas. The purge gas prevents contamination of the surface, for example, by molecular contamination with hydrocarbons.

A drawback of this method is that the purge gas may have an adverse effect on the activity of chemicals used in the lithographic process. Thus, there is a need for a modified purge gas that reduces the contamination of optical components in a lithographic projection system but does not adversely affect the activity of chemicals used in lithographic processes.

### SUMMARY

Versions of the present invention comprise a lithographic projection apparatus that can include an illuminator configured to provide a beam of radiation and a support structure configured to support a patterning device. The patterning device is configured to pattern the beam of radiation according to a desired pattern. A substrate table is configured to hold a substrate. A projection system is configured to project the patterned beam onto a target portion of the substrate. At least one purge gas supply system is configured to provide a purge gas to at least part of the lithographic projection apparatus. The at least one purge gas supply system has a purge gas mixture generator that includes a vaporizer configured to add vapor to a purge gas to form a purge gas mixture. In some versions the purge gas consists essentially of the purge gas and vapor from a vaporizable liquid. In some embodiments the purge gas mixture can comprise a purge gas and vapor from a vaporizable liquid. The vaporizable liquid forms a non-contaminating vapor in the purge gas and the mixture is used to reduce or eliminate contamination optical components in the lithographic projection apparatus and to maintain the chemical activity of a coating on a substrate. A purge gas mixture outlet is connected to the purge gas mixture generator and can be configured to supply the purge gas mixture to the at least part of the lithographic projection apparatus. The vaporizer in the purge gas mixture generator adds vapor to the purge gas at high flow rates while not contributing more than 1 part per trillion of contaminants to the purge gas. In some embodiments the vaporizer in the purge gas mixture generator adds vapor to the purge gas at high flow rates while not contributing to the purge gas more than about 1 part per billion contaminants that degrade the optical properties of optical components in a lithographic projection system.

It is an aspect of the present invention to provide an improved lithographic projection apparatus, and in particular a lithographic projection apparatus in which contamination can be reduced with a purge gas without affecting the development of the resist.

According to one aspect of the invention, a lithographic projection apparatus includes an illuminator configured to provide a beam of radiation and a support structure configured to support a patterning device. The patterning device is configured to pattern the beam of radiation according to a desired pattern. A substrate table is configured to hold a substrate. A projection system is configured to project the patterned beam onto a target portion of the substrate. At least one purge gas supply system is configured to provide a purge gas to at least part of the lithographic projection apparatus. The at least one purge gas supply system can comprise a purge gas mixture generator that includes a vaporizer or vaporizer configured to add moisture to a purge gas. The purge gas mixture generator is configured to generate a purge gas mixture. The purge gas mixture includes at least one purge gas and the moisture. A purge gas mixture outlet is connected to the purge gas mixture generator and is configured to supply the purge gas mixture at least a part of the lithographic projection apparatus. Thus, moisture is present and the activity of chemicals, e.g. the development of the resists, is not affected by the purge gas mixture.

According to a still further aspect of the present invention, a purge gas supply system includes a purge gas mixture generator comprising a moisturizer configured to add moisture to a purge gas. The purge gas mixture generator configured to generate a purge gas mixture including at least one purging gas and the moisture and comprising a purge gas outlet. In one example, the purge gas outlet is configured to supply the purge gas mixture to at least a part of a lithographic projection apparatus. In one version of the invention the purge gas mixture is a composition that consists of a purge gas and moisture, the composition contains less than about 1 part per billion of contaminants that have an adverse effect on the optical properties of optical components interacting with the radiation to form a pattern on a substrate in a lithographic projection apparatus.

In a preferred embodiment, the purge gas mixture supply system includes a purge gas source; a water source; and a purge gas mixture generator having a moisturizer configured to add moisture to a purge gas. Optionally, the supply system also includes a heating device for the water, such that the water is heated in or prior to entering the moisturizer.

In one version of the invention, the vaporizer is a moisturizer for the purge gas supply system and the lithographic protection apparatus preferably includes a first region containing a purge gas flow and a second region containing water where the first and second regions are separated by a gas-permeable membrane of the vaporizer that is substantially resistant to liquid intrusion by the vaporizable liquid. More preferably, the moisturizer contains a bundle of a plurality of perfluorinated gas-permeable thermoplastic hollow fiber membranes having a first end and a second end, where the membranes have an outer surface and an inner surface and inner surface includes a lumen, each end of the bundle potted with a liquid tight perfluorinated thermoplastic seal forming a unitary end structure with a surrounding perfluorinated thermoplastic housing where the fiber ends are open to fluid flow. The housing has an inner wall and an outer wall, where the inner wall defines a fluid flow volume between the inner wall and the hollow fiber membranes; the housing includes a purge gas inlet connected to the purge gas source and a purge gas mixture outlet. The housing includes a water inlet connected to the water source and a water outlet, where either the purge gas inlet is connected to the first end of the bundle and the purge gas mixture outlet is connected to the second end of the bundle or the water inlet is connected to the first end of the bundle and the water outlet is connected to the second end of the bundle, and wherein the purge gas mixture contains at least one purge gas and the moisture.

According to another aspect of the present invention, a method for adding vapor to a purge gas includes passing the purge gas through the vaporizer described above for a period sufficient to add vapor to the purge gas. The purge gas containing the vapor is provided to at least a part of a lithographic projection apparatus. In one embodiment, the vapor is water vapor and the includes the acts of generating a purge gas mixture having at least one purge gas and moisture by adding moisture to a purge gas, and supplying the purge gas mixture to at least a part of the lithographic projection apparatus, where the purge gas mixture includes a purge gas and moisture. Thus, chemicals used in the lithographic projection apparatus are not affected by the purge gas.

According to a further aspect of the invention, a device manufacturing method includes applying the method described above to at least a part of a substrate at least partially covered by a layer of radiation sensitive material, projecting a patterned beam of radiation onto a target portion of the layer of radiation-sensitive material; and supplying the purge gas mixture near a surface of a component used in the device manufacturing method.

Further details, aspects and embodiments of the invention will be described, by way of example only, with reference to the attached drawings.

### BRIEF DESCRIPTION OF THE DRAWINGS

FIG. 1 schematically shows an example of an embodiment of a lithographic projection apparatus according to a version of the present invention.

FIG. 2 shows a side view of an EUV illuminating system and projection optics of a lithographic projection apparatus according to an embodiment of the present invention.

FIG. 3 schematically illustrates an example of a purge gas mixture supply system according to an embodiment of the present invention.

FIG. 4 schematically shows a moisturizer device suitable for use in the example of FIG. 3.

FIG. 5 is an illustration of a hollow fiber membrane vaporizer or moisturizer, which can be used in the example of FIG. 3.

FIG. 6 shows the membrane contactor test manifold used in Example 1.

FIG. 7 shows the gas chromatography/flame ionization detector (GC/FID) reading for extra-clean dry air (XCDA).

FIG. 8 shows the GC/FID reading for XCDA that has passed through a moisturizer, as described in Example 1.

FIG. 9 shows the gas chromatography/pulse flame photometric detector (GC/PFPD) reading for XCDA.

FIG. 10 shows the GC/PFPD reading for XCDA that has passed through a moisturizer, as described in Example 1.

FIG. 11(A) illustrates a version of a purge gas supply system having a source of purge gas for dilution of a purge gas mixture; an optional trap is also shown; FIG. 11(B) illustrates a version of a purge gas supply system having a source of purge gas for dilution of a purge gas mixture and a heat exchange zone to maintain the temperature of the purge gas mixture from the vaporizer or moisturizer.

FIG. 12 is a graph illustrating the vapor output relative to saturation at two different gas outlet pressures from a vaporizer where water at 18 psig is the vaporizable liquid.

FIG. 13 (A) is a graph illustrating the vapor output relative to saturation from a vaporizer at different flow rates and gas pressures for a vaporizable liquid like water in the vaporizer at 59 psig; FIG. 13(B) is a graph of calculated concentration of the vapor in the purge gas mixture at different gas pressures in the vaporizer.

FIG. 14 is an illustration of an apparatus for generating a purge gas mixture with one or more hollow fiber vaporizers connected together.

FIG. 15 is a graph that illustrates that the vapor concentration in a purge gas that flows through a hollow fiber vaporizer can be controlled to a range that is essentially independent of the purge gas flow rate through the vaporizer.

### DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “hollow fibers” is a reference to one or more hollow fibers and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

Versions of the present invention provide both an apparatus and a method for adding a vapor to a purge gas. Although such vapor consisting or vapor comprising purge gases are particularly beneficial in lithographic systems, their use is not limited to such systems. Introducing vapor into a system by a method of the invention avoids methods of introducing vapor that may contaminate the purge gas. Some versions of the invention provide an apparatus and a method for adding water vapor to a purge gas. Although such humidified purge gases are particularly beneficial in lithographic systems, their use is not limited to such systems. Introducing water into a system by a method of the invention avoids methods of introducing water that may contaminate the purge gas.

The term patterning device as here employed should be broadly interpreted as referring to a device that can be used to endow an incoming radiation beam with a patterned cross-section corresponding to a pattern that is to be created in a target portion of the substrate. The term “light valve” can also be used in this context. Generally, the pattern will correspond to a particular functional layer in a device being created in the target portion, such as an integrated circuit or other device (see below). An example of such a patterning device is a mask. The concept of a mask is well known in lithography, and it includes mask types such as binary, alternating phase-shift, and attenuated phase-shift, as well as various hybrid mask types. Placement of such a mask in the radiation beam causes selective transmission (in the case of a transmissive mask) or reflection (in the case of a reflective mask) of the radiation impinging on the mask, according to the pattern on the mask. In the case of a mask, the support will generally be a mask table, which ensures that the mask can be held at a desired position in the incoming radiation beam, and that it can be moved relative to the beam if so desired.

Another example of a patterning device is a programmable mirror array. One example of such an array is a matrix-addressable surface having a viscoelastic control layer and a reflective surface. The basic principle behind such an apparatus is that, for example, addressed areas of the reflective surface reflect incident light as diffracted light, whereas unaddressed areas reflect incident light as undiffracted light. Using an appropriate filter, the undiffracted light can be filtered out of the reflected beam, leaving only the diffracted light behind. In this manner, the beam becomes patterned according to the addressing pattern of the matrix-addressable surface. An alternative embodiment of a programmable mirror array employs a matrix arrangement of tiny mirrors, each of which can be individually tilted about an axis by applying a suitable localized electric field, or by employing piezoelectric actuators. Once again, the mirrors are matrix-addressable, such that addressed mirrors will reflect an incoming radiation beam in a different direction to unaddressed mirrors. In this manner, the reflected beam is patterned according to the addressing pattern of the matrix-addressable mirrors. The required matrix addressing can be performed using suitable electronics. In both of the situations described hereabove, the patterning device can comprise one or more programmable mirror arrays. More information on mirror arrays as here referred to can be seen, for example, from U.S. Pat. Nos. 5,296,891 and 5,523,193, and PCT publications WO 98/38597 and WO 98/33096. In the case of a programmable mirror array, the structure may be embodied as a frame or table, for example, which may be fixed or movable.

Another example of a patterning device is a programmable LCD array. An example of such a construction is given in U.S. Pat. No. 5,229,872. As above, the support structure in this case may be embodied as a frame or table, for example, which may be fixed or movable.

For purposes of simplicity, the rest of this text may, at certain locations, specifically direct itself to examples involving lithographic apparatuses such as a mask and mask table. However, the general principles discussed in such instances should be seen in the broader context of adding a vapor to a purge gas, for example adding water vapor using a purge gas generator to humidify a purge gas as described herein.

Lithographic projection apparatus can be used, for example, in the manufacture of integrated circuits (IC's). In such a case, the patterning device may generate a circuit pattern corresponding to an individual layer of the IC, and this pattern can be imaged onto a target portion (e.g. comprising one or more dies) on a substrate (silicon wafer) that has been coated with a layer of radiation-sensitive material (resist). In some versions of the invention, a single wafer will contain a whole network of adjacent target portions that are successively irradiated via the projection system, one at a time. In the current apparatus, employing patterning by a mask on a mask table, a distinction can be made between two different types of machine. In one type of lithographic projection apparatus, each target portion is irradiated by exposing the entire mask pattern onto the target portion at once. Such an apparatus is commonly referred to as a wafer stepper. In an alternative apparatus, commonly referred to as a step-and-scan apparatus, each target portion is irradiated by progressively scanning the mask pattern under the beam of radiation in a given reference direction (the “scanning” direction) while synchronously scanning the substrate table parallel or anti-parallel to this direction. Since, in general, the projection system will have a magnification factor M (generally <1), the speed V at which the substrate table is scanned will be a factor M times that at which the mask table is scanned. More information with regard to lithographic devices as here described can be seen, for example, from U.S. Pat. No. 6,046,792.

In a known manufacturing process using a lithographic projection apparatus, a pattern (e.g., in a mask) is imaged onto a substrate that is at least partially covered by a layer of radiation-sensitive material (resist). Prior to this imaging, the substrate may undergo various procedures, such as priming, resist coating and a soft bake. After exposure, the substrate may be subjected to other procedures, such as a post-exposure bake (PEB), development, a hard bake and measurement/inspection of the imaged features. This array of procedures is used as a basis to pattern an individual layer of a device, e.g., an IC. Such a patterned layer may then undergo various processes such as etching, ion-implantation (doping), metallization, oxidation, chemo-mechanical polishing, etc., all intended to complete processing of an individual layer. If several layers are required, then the whole procedure, or a variant thereof, will have to be repeated for each new layer. The overlay juxtaposition) of the various stacked layers allows multilayer device structures to be manufactured. For this purpose, a small reference mark is provided at one or more positions on the wafer, thus defining the origin of a coordinate system on the wafer. Using optical and electronic devices in combination with the substrate holder positioning device (referred to hereinafter as “alignment system”), this mark can then be relocated each time a new layer has to be juxtaposed on an existing layer, and can be used as an alignment reference. Eventually, an array of devices will be present on the substrate (wafer). These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4.

For the sake of simplicity, the projection system may hereinafter be referred to as the “lens.” However, this term should be broadly interpreted as encompassing various types of projection system, including refractive optics, reflective optics, and catadioptric systems, for example. The radiation system may also include components operating according to any of these design types for directing, shaping or controlling the beam of radiation, and such components may also be referred to below, collectively or singularly, as a “lens”. Further, the lithographic apparatus may be of a type having two or more substrate tables (and/or two or more mask tables). In such “multiple stage” devices, the additional tables may be used in parallel or preparatory steps that may be carried out on one or more tables while one or more other tables are being used for exposures. Dual stage lithographic apparatuses are described, for example, in U.S. Pat. No. 5,969,441 and U.S. Pat. No. 6,262,796.

Although specific reference may be made in this text to the use of the apparatus according to the invention in the manufacture of ICs, it should be explicitly understood that such an apparatus has many other possible applications.

For example, it may be employed in the manufacture of integrated optical systems, guidance and detection patterns for magnetic domain memories, liquid-crystal display panels, thin-film magnetic heads, etc. One of ordinary skill in the art will appreciate that, in the context of such alternative applications, any use of the terms “reticle”, “wafer” or “die” in this text should be considered as being replaced by the more general terms “mask”, “substrate” and “target portion”, respectively.

In the present document, the terms “radiation” and “beam” are used to encompass all types of electromagnetic radiation used to pattern a resist on a substrate. These can include x-rays, ultraviolet (UV) radiation (e.g., with a wavelength of 365 nm, 248 nm, 193 nm, 157 nm, or 126 nm) and extreme ultra-violet (EUV) radiation (e.g., having a wavelength in the range 5-20 nm), as well as particle beams, such as ion beams or electron beams.

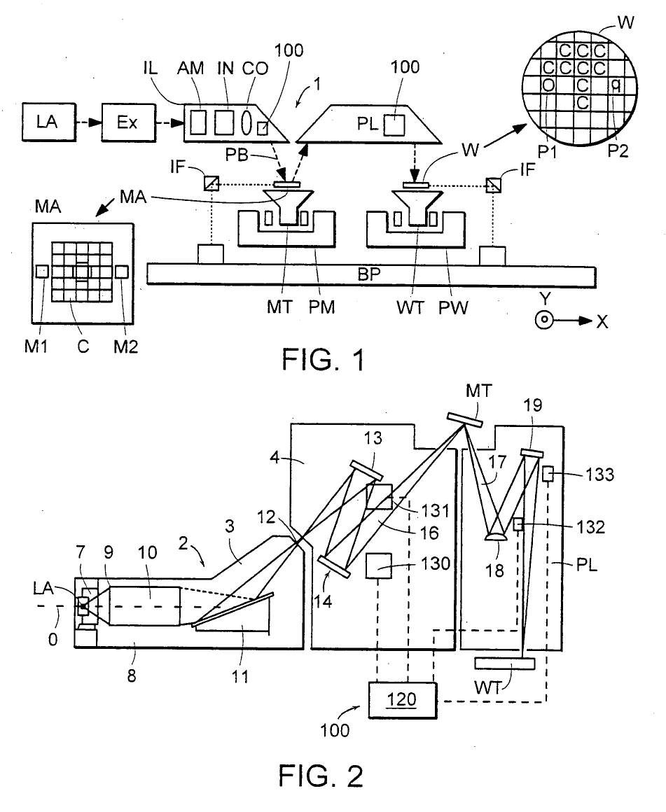

FIG. 1 schematically depicts a lithographic projection apparatus 1 according to an embodiment of the present invention. The apparatus 1 includes a base plate BP. The apparatus may also include a radiation source LA (e.g., EITV radiation). A first object (mask) table MT is provided with a mask holder configured to hold a mask MA (e.g., a reticle), and is connected to a first positioning device PM that accurately positions the mask with respect to a projection system or lens PL. A second object (substrate) table WT is provided with a substrate holder configured to hold a substrate W (e.g., a resist-coated silicon wafer), and is connected to a second positioning device PW that accurately positions the substrate with respect to the projection system PL. The projection system or lens PL (e.g. a mirror group) is configured to image an irradiated portion of the mask MA onto a target portion C (e.g., comprising one or more dies) of the substrate W.

As here depicted, the apparatus is of a reflective type (i.e., has a reflective mask). However, in general, it may also be of a transmissive type, for example, with a transmissive mask. Alternatively, the apparatus may employ another kind of patterning device, such as a programmable mirror array of a type as referred to above. The source LA (e.g., a discharge or laser-produced plasma source) produces radiation. This radiation is fed into an illumination system (illuminator) IL, either directly or after having traversed a conditioning device, such as a beam expander EX, for example. The illuminator IL may include an adjusting device AM that sets the outer and/or inner radial extent (commonly referred to as s-outer and s-inner, respectively) of the intensity distribution in the beam. In addition, it will generally comprise various other components, such as an integrator IN and a condenser CO. In this way, the beam PB impinging on the mask MA has a desired uniformity and intensity distribution in its cross-section.

It should be noted with regard to FIG. 1 that the source LA may be within the housing of the lithographic projection apparatus, as is often the case when the source LA is a mercury lamp, for example, but that it may also be remote from the lithographic projection apparatus. The radiation which it produces is led into the apparatus. This latter scenario is often the case when the source LA is an excimer laser. The present invention encompasses both of these scenarios.

The beam PB subsequently intercepts the mask MA, which is held on a mask table MT. Having traversed the mask MA, the beam PB passes through the lens PL, which focuses the beam PB onto a target portion C of the substrate W. With the aid of the second positioning device PW and interferometer IF, the substrate table WT can be moved accurately, e.g., so as to position different target portions C in the path of the beam PB. Similarly, the first positioning device PM can be used to accurately position the mask MA with respect to the path of the beam PB, e.g. after mechanical retrieval of the mask MA from a mask library, or during a scan. In general, movement of the object tables MT, WT will be realized with the aid of a long-stroke module (coarse positioning) and a short-stroke module (fine positioning), which are not explicitly depicted in FIG. 1. However, in the case of a wafer stepper (as opposed to a step and scan apparatus) the mask table MT may just be connected to a short stroke actuator, or may be fixed. The mask MA and the substrate W may be aligned using mask alignment marks M1 and M2 and substrate alignment marks P1 and P2.

The depicted apparatus can be used in two different modes: (1.) In step mode, the mask table MT is kept essentially stationary, and an entire mask image is projected at once, i.e. a single “flash,” onto a target portion C. The substrate table WT is then shifted in the X and/or Y directions so that a different target portion C can be irradiated by the beam PB; (2.) In scan mode, essentially the same scenario applies, except that a given target portion C is not exposed in a single “flash.” Instead, the mask table MT is movable in a given direction (the so-called “scan direction”, e.g., the Y direction) with a speed v, so that the beam of radiation PB is caused to scan over a mask image. Concurrently, the substrate table WT is simultaneously moved in the same or opposite direction at a speed, V=Mv, in which M is the magnification of the lens PL (typically, M=¼ or ⅕). In this manner, a relatively large target portion C can be exposed, without having to compromise on resolution.

FIG. 2 shows the projection system PL and a radiation system 2 that can be used in the lithographic projection apparatus 1 of FIG. 1. The radiation system 2 includes an illumination optics unit 4. The radiation system 2 can also comprise a source-collector module or radiation unit 3. The radiation unit 3 is provided with a radiation source LA that can be formed by a discharge plasma. The radiation source LA may employ a gas or vapor, such as Xe gas or Li vapor in which a very hot plasma may be created to emit radiation in the EUV range of the electromagnetic spectrum. The very hot plasma is created by causing a partially ionized plasma of an electrical discharge to collapse onto the optical axis 0. Partial pressures of 0.1 mbar of Xe, Li vapor, or any other suitable gas or vapor may be required for efficient generation of the radiation. The radiation emitted by radiation source LA is passed from the source chamber 7 into collector chamber 8 via a gas barrier structure or “foil trap” 9. The gas barrier structure 9 includes a channel structure such as, for instance, described in detail in U.S. Pat. No. 6,862,075 and U.S. Pat. No. 6,359,969.

The collector chamber 8 comprises a radiation collector 10, which can be a grazing incidence collector. Radiation passed by collector 10 is reflected off a grating spectral filter 11 to be focused in a virtual source point 12 at an aperture in the collector chamber 8. From chamber 8, the projection beam 16 is reflected in illumination optics unit 4 via normal incidence reflectors 13 and 14 onto a reticle or mask positioned on reticle or mask table MT. A patterned beam 17 is formed, which is imaged in projection system PL via reflective elements 18 and 19 onto a wafer stage or substrate table WT. More elements than shown may generally be present in illumination optics unit 4 and projection system PL.

As is shown in FIG. 2, the lithographic projection apparatus 1 includes a purge gas supply system 100. Purge gas outlets 130-133 of the purge gas supply system 100 are positioned in the projection system PL and the illumination optics unit 4 near the reflectors 13 and 14 and the reflective elements 18 and 19, as is shown in FIG. 2. However, if so desired, other parts of the apparatus may likewise be provided with a purge gas supply system. For example, a reticle and one or more sensors of the lithographic projection apparatus may be provided with a purge gas supply system.

In FIGS. 1 and 2, the purge gas supply system 100 is positioned inside the lithographic projection apparatus 1. The purge gas supply system 100 can be controlled in any manner suitable for the specific implementation using any device outside the apparatus 1. However, it is likewise possible to position at least some parts of the purge gas supply system 100 outside the lithographic projection apparatus 1, for example the purge gas mixture generator 120.

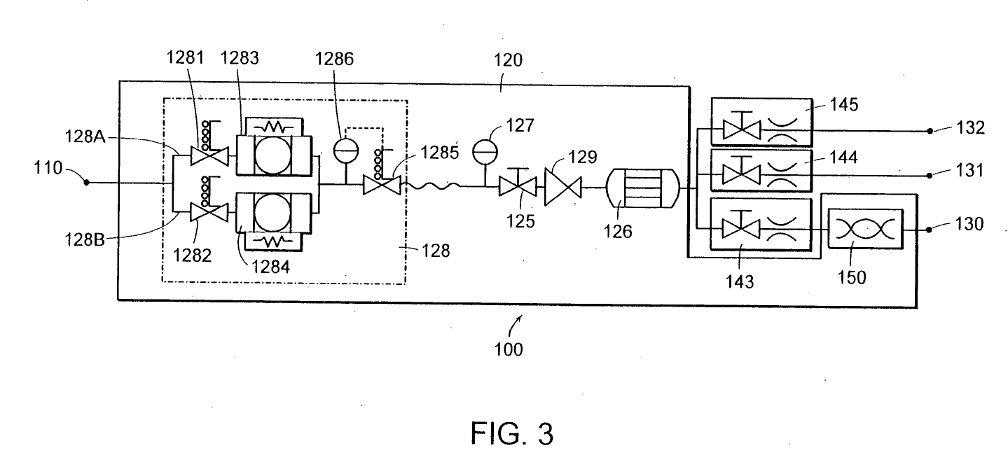

FIG. 3 shows an embodiment of a purge gas supply system 100. A purge gas inlet 10 is connected to a purge gas supply apparatus (not shown) that supplies a dry gas that is substantially without moisture, for example, a pressurized gas supply circuit, a cylinder with compressed dry air, nitrogen, helium or other gas. The dry gas is fed through the purge gas mixture generator 120. In the purge gas mixture generator 120 the dry gas is purified further, as explained below. Further, the purge gas mixture generator 120 includes a vaporizer 150 that adds a vapor to the purge gas to form a purge gas mixture. For example in one version of the invention the vaporizer is a moisturizer 150 which adds moisture to the dry gas for the purge gas mixture outlet 130. The other purge gas outlets 131 and 132 as shown in this embodiment are not connected to the moisturizer 150. Various combinations of purge gas outlets and purge gas mixture outlets may be present in other embodiments of the purge gas generator. Thus, at the purge gas mixture outlet 130, a purge gas mixture including the purge gas and moisture is presented, whereas at the other purge gas outlets 131 and 132 only the dry purge gas is presented. Thereby the purge gas mixture may be provided only near surfaces provided with chemicals that require a vapor such as moisture, such as the wafer table WT, whereas other parts of the lithographic projection apparatus 1 can be provided with a dry purge gas, i.e., without a vapor like moisture. Nevertheless, the invention is not limited to purge gas mixture generators where only one outlet of the generator supplies the purge gas mixture.

Furthermore, because the vapor like moisture is added to a purge gas, properties of the purge gas mixture, such as the concentration or purity of the vapor, can be controlled with good accuracy. For example, good accuracy can be the concentration of vapor in the purge gas to form a purge gas mixture that is achieved by controlling the temperature of the purge gas, vaporizable liquid, or combination of these to about ± 1° C. or less. The concentration of the vapor in the purge gas can be controlled by maintaining the pressure between the gas and liquid such that gas does not intrude into the liquid and the vapor concentration in the purge gas is essentially constant to within about 5% or less. The concentration of vapor in the purge gas can be maintained by controlling the temperature, pressure, purge gas flow rate or any combination of these so that the concentration of the vapor in the purge gas is essentially constant, for example the vapor concentration in the purge gas mixture varies by about 5% or less, in some versions it varies by 1% or less, and in still other versions the concentration of the vapor in the purge gas mixture less than about 0.5% during the time over which the purge gas mixture is made.

The concentration of moisture in a purge gas mixture can be that achieved by controlling the flow rate of the purge gas into the vaporizer, the flow rate of a diluent purge gas mixed with the purge gas mixture, or any combination of these to achieve a vapor concentration that varies by 5% or less.

In some versions, the concentration of moisture in the purge gas can be controlled by a vaporizable liquid pressure that is about 5 psig or more above the purge gas pressure. The pressure difference between the purge gas and liquid can be controlled by one or more pressure regulators that have a repeatability of about 5% or less and in some versions about ±0.5% less.

The output from a moisture probe downstream of the moisturizer may be used with a controller in a control loop to adjust the purge gas or vaporizable liquid pressure in the vaporizer, to adjust the temperature of the vaporizable liquid or purge gas in the vaporizer, to adjust the amount of a dilution purge gas added to the purge gas mixture, or any combination of these to achieve an amount of vapor in the purge gas to form a purge gas mixture that provides a vapor concentration that varies by less than 5% in some versions of the invention, by less than 1% in some versions, and in still other versions by less than 0.5%. It can be advantageous to maintain the temperature of the purge gas or purge gas mixture to a temperature range within the lithographic process tolerances to minimize thermal expansion or contraction of optical elements in the projection apparatus and to reduce changes in refractive index. It can be advantageous to maintain the concentration of vapor in a purge gas mixture within these ranges to minimize changes in refractive index and the outcome of interferometric measurements. Advantageously, the vaporizer of the system is flexible, and for example in the case of water, the vaporizer allows the amount of water vapor present in the purge gas mixture to easily be adjusted by adding more or less water vapor to the purge gas.

As illustrated in FIG. 15 where the vapor is water vapor, by modifying the temperature and flow rate of the vaporizer, the vapor concentration can be controlled to a range that is essentially independent of the purge gas flow rate through the vaporizer. In some versions the vapor concentration can be controlled to less than about 5% of the vapor concentration in the purge gas mixture, in some embodiments less than about 1%, and in still other embodiments less than about 0.5%. As shown in FIG. 15, the vaporizer in versions of the present invention can provide a purge gas mixture with a water vapor concentration at about 40 slm flow of about 6314 ppm, a moisture concentration at about 80 slm flow of about 6255 ppm, and a moisture concentration at about 120 slm flow of about 6286 ppm. This essentially constant moisture concentration varies by less than about 0.5% across the flow rate of purge gas through the vaporizer.

In some versions of the purge gas mixture generator 120, the generator can include in a flow direction: a purifier apparatus 128, a flow meter 127, a valve 125, a reducer 129, a heat exchanger 126 and the moisturizer 150.

A source of gas for the purge gas can be supplied to the purifier apparatus 128 via the purge gas inlet 110. For example, a compressed dry air (CDA) from a CDA source (not shown) can be supplied to the purifier apparatus 128 via the purge gas inlet 110. The CDA is purified by the purifier 128. The purifier 128 includes two parallel flow branches 128A and 128B each including, in the flow direction: an automatic valve 1281 or 1282 and a regenerable purifier device 1283 or 1284. The regenerable purifier devices 1283 and 1284 are each provided with a heating element to heat and thereby regenerate the respective purifier devices 1283 and 1284 separately and independently. For example, one purifier can be used to make the purge gas while the other purifier is off-line being regenerated. The flow branches are connected downstream of the purifier devices 1283 and 1284 to a shut-off valve 1285 that can be controlled by a gas purity sensor 1286.

Because purifiers are regenerable, the system can be used for a long time by regenerating the purifiers seperately in case they become saturated with the compounds removed from the purge gas. The regenerable purifiers may be of any suitable type, for example, a regenerable filter which removes contaminating compounds or particles out of a gas by a physical process, such as adsorption, catalysis or otherwise, as opposed to non-regenerable chemical processes occurring in a charcoal filter, for example. In general, a regenerable purifier does not contain organic material and the regenerable purifiers typically contain a material suitable for physically binding a contaminant of the purge gas, such as metals, including zeolite, titanium oxides, gallium or palladium compounds, or others. Preferred purifiers are inert gas and oxygen-compatible purifiers such as the Aeronex Inert or XCDA purifiers (CE-70KF-I, O, or N) available from Mykrolis Corp. In some versions of the invention, suitable purifiers provide a purge gas with less than 1 part per trillion of contaminant such as hydrocarbons, NOx, or others.

The purifier devices 1283 and 1284 can alternately be put in a purifying state, in which the clean dry air (CDA) or other gas is purified, and a regenerating state. In the regenerating state, the purifier device is regenerated by the respective heating element. Thus, for example, while the purifier device 1283 purifies the CDA, the purifier device 1284 is regenerated separately and independently. The purifier apparatus 128 can thus operate continuously while maintaining a constant level of gas purification.

The automatic valves 1281 and 1282 are operated in correspondence with the operation of the corresponding purifier device 1283 and 1284. Thus, when a purifier device 1283 or 1284 is regenerated, the corresponding valve 1281 or 1282 is closed. When a purifier device 1283 or 1284 is used to purify, the corresponding valve 1281 or 1282 is open.

In one embodiment, the purified gas such as purified CDA is fed through the shut-off valve 1285, which is controlled by the purity sensor 1286. The purity sensor 1286 automatically closes the shut-off valve 1285 when the purity of the purified CDA is below a predetermined threshold value. Thus, contamination of the lithographic projection apparatus 1 with a purge gas with insufficient purity levels is prevented automatically.

The flow of purified CDA can be monitored via the flow meter 127. The valve 125 can be used to shut-off the flow manually. The reducer 129 provides a stable pressure at the outlet of the reducer, thus a stable purge gas pressure can be provided to restrictions 143-145 (via the heat exchanger 126).

The heat exchanger 126 provides a purified CDA at a substantially constant temperature. The heat exchanger 126 extracts or adds heat to the purified gas such as purified CDA in order to achieve a gas temperature that is suitable for the specific implementation. In a lithographic projection apparatus, for example, stable processing conditions are used and the heat exchanger may thus stabilize the temperature of the purified CDA to have a gas temperature that is constant or in a predetermined narrow temperature range over time. Suitable conditions for the purge gas at the purge gas outlets in lithographic applications, for example, can be a flow of 20-30 standard liters per minute, and/or a temperature of the purge gas of about 22 degrees Celsius and/or a relative humidity in the range of 30-60%. However, the invention is not limited to these conditions and other values for these parameters may likewise be used in a system according to the present invention. The heat exchanger may be used to condition the temperature of the purge gas to modify the uptake of vapor from a vaporizable liquid in a vaporizer.

The heat exchanger 126 can be connected via restrictions 143-145 to the purge gas outlets 130-132. The restrictions 143-145 can be used to limit the gas flow, such that at each of the purge gas outlets 130-132 a desired, fixed purge gas flow and pressure is obtained. A suitable value for the purge gas pressure at the purge gas outlets can be, for example, 100 mbar. It is likewise possible to use adjustable restrictions to provide an adjustable gas flow at each of the purge gas outlets 131-132 and purge gas mixture outlet 130.

The vaporizer, for example the moisturizer 150, is connected downstream from the heat exchanger between the restriction 143 and the purge gas outlet 130. The purge gas mixture outlet 130 is provided in the example of FIGS. 1 and 2 near the wafer table WT. The moisturizer 150, adds moisture or water vapor to the purified CDA and thus provides a purge gas mixture to the outlet 130. In this example, only at a single outlet a purge gas mixture is discharged. However, it is likewise possible to discharge a purge gas mixture to two or more purge gas outlets, for example by, connecting a multiple of purge gas outlets to separate moisturizers or connecting two or more outlets to the same moisturizer. It is likewise possible to provide a vaporizer, such as a moisturizer, at a different positions in the purge gas mixture generator than is shown in FIG. 3. For example, the moisturizer 150 may be placed between the purge gas mixture generator 120 and the valve 143 instead of between the valve 143 and the purge gas outlet 130. The moisturizer or other vaporizer 150 can act or operate as a flow restriction as well, and if so desired, the restriction 130 connected to the moisturizer 150 may be omitted.

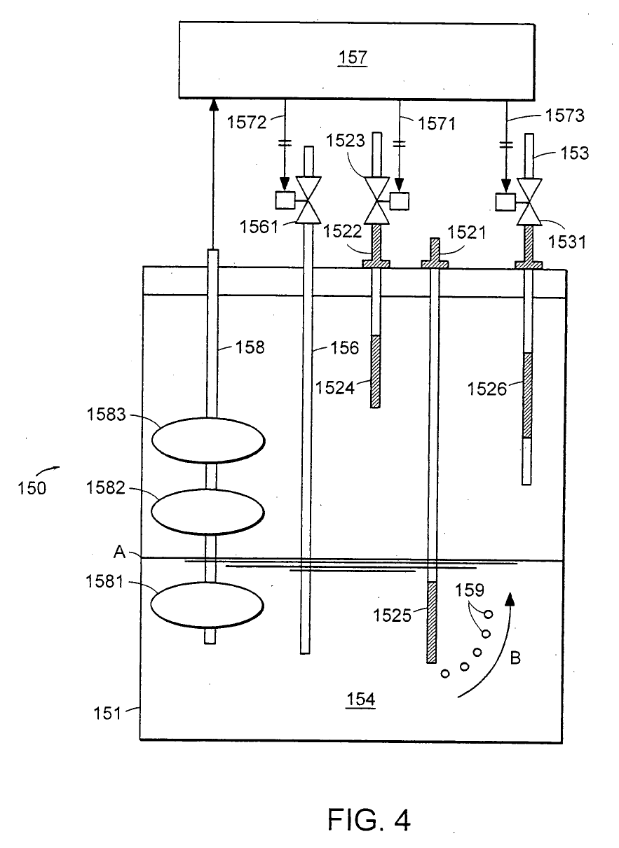

The moisturizer 150 may, for example, be implemented as shown in FIG. 4. However, the moisturizer 150 may likewise be implemented differently, and, for example, include a vaporizer which vaporizes a fluid into a flow of purge gas.

The moisturizer 150 shown in FIG. 4 includes a liquid vessel 151 which is filled to a liquid level A with a vaporizable liquid 154, such as high purity water for example. A gas inlet 1521 (hereinafter “wet gas inlet 1521”), is placed mounding submerged in the liquid 154, that is below the liquid level A. Another gas inlet 1522 (hereinafter “dry gas inlet 1522”), is placed mounding above the liquid level A, that is in the part of the liquid vessel 151 not filled with the liquid 154. A gas outlet 153 connects the part of the liquid vessel 153 above the liquid 154 with other parts of the purge gas supply system 100. In this version of a vaporizer, a purge gas, e.g. purified compressed dry air, is fed into the liquid vessel 151 via the wet gas inlet 1521. Thus, bubbles 159 of purge gas are generated in the liquid 154. Due to buoyancy, the bubbles 159 travel upwards after mounding in the liquid 154, as indicated in FIG. 4 by arrow B. Without wishing to be bound by theory, during this upwards traveling period, moisture from the liquid 154 enters the bubbles 159, for example due to diffusive processes. Thus, the purge gas in the bubbles 159 is mixed with moisture. At the surface of the liquid i.e. at the liquid level A, the bubbles 159 supply their gaseous content to the gas(es) present in the liquid vessel 151 above the liquid 154. The resulting purge gas mixture is discharged from the vessel via the gas outlet 153.

The wet gas inlet 1521 can be a tubular element with an outside end connected outside the liquid vessel 151 to a purge gas supply device (not shown), such as the purge gas mixture generator 120 of FIG. 3. The vapor containing or wet gas inlet 1521 is provided with a filter element 1525 with small, e.g. 0.5 micron, passages at an inside end which is positioned in the inside of the liquid vessel 151. The filter element 1525 is at least partially, in this embodiment entirely, placed in the liquid 154. Thus, the wet gas inlet 1521 generates a large amount of very small bubbles of purge gas. Because of their small size (e.g., about 0.5 micron), the bubbles 159 are moisturized to saturation in a relatively short time period, i.e. a relatively short traveling distance through the liquid 154.

The dry gas inlet 1522 is provided with a filter element 1524 similar to the filter element of the wet gas inlet 1521. Thereby, the gas flow through the wet gas inlet 1521 and the dry gas inlet 1522 is substantially similar, and the amount of moisture in the purge gas mixture is substantially half the amount of moisture in the bubbles 159 at the moment the bubbles 159 leave the liquid 154. That is, if the bubbles 159 are saturated with moisture, i.e., 100% relative humidity (Rh), the purge gas mixture has a 50% Rh. However, it is likewise possible to provide in a different ratio of gas flowing into the liquid vessel via the wet gas inlet 1521 and the dry gas inlet 1522 respectively and thereby adjust the relative humidity between about 0 and about 100% Rh.

The gas outlet 153 is provided at its inside end with a fine-meshed, e.g. 0.003 micron, filter 1526 which can be used to filter particles and small droplets out of the gas flowing out of the liquid vessel 151. Thus, contamination of the surface to which the purge gas mixture is supplied by such particles is reduced.

The relative amount of moisture in the purge gas mixture can be controlled in different ways. For example, parameters of the liquid vessel 151 such as the height of the liquid that the gas bubbles travel can be controlled. Also, for example, the amount of purge gas without moisture brought into the vessel 151 via the dry gas inlet 1522 relative to the amount of purge gas with moisture generated via the wet gas inlet 1521 can be controlled. The controlled parameters of the liquid vessel 151 may for example be one or more of the inside temperature, flow, pressure, residence time of the purge gas in the liquid.

Temperature is known to have an effect on the saturation amount of a vapor like moisture that can be present in a gas, for example. To control the temperature, the liquid vessel 151 may be provided with a heating element which is controlled by a control device, or controller, in response to a temperature signal representing a temperature inside the liquid vessel provided by a temperature measuring device, for example.

The residence time of the bubbles in the vaporizable liquid 154 can be changed by adjusting the position at which the gas bubbles are inserted in the liquid via the wet gas inlet 1521. For example, when the filter 1525 is positioned further into the liquid 154, the distance the bubbles have to travel to the liquid level A is increased and hence the residence time increases as well. The longer the gas bubbles are present in the liquid 154, the more vapor such as water vapor that can be absorbed into the gas. Thus, by changing the residence time the vapor content, for example the humidity, of the gas can be adapted.

The moisturizer device 150 is further provided with a control device 157 via which the amount of a vapor such as water vapor in the purge gas mixture can be controlled. For example, the control device 157 can be connected with a moisture control contact 1571 to a control valve 1523 in the dry gas inlet 1522 via which the flow rate of the purge gas supplied to the dry inlet 1522 can be controlled and therefore the amount of dry purge gas relative to the amount of moisturized gas.

The control device 157 further controls the amount of liquid 154 present in the liquid vessel 151. The control device 157 is connected with a liquid control contact 1572 to a control valve 1561 of a liquid supply 156 and with an overflow contact 1573 to a control valve 1531 of the gas outlet 153. A liquid level measuring device 158 is communicatively connected to the control device 157. The liquid level measuring device 158 provides a liquid level signal to the control device 157 which represents a property of the liquid level in the liquid vessel 151. The control device 157 operates the control valve 1561 and the control valve 1531 in response to the vaporizable liquid level signal.

In this example, the liquid level measuring device 158 includes three float switches 1581-1583 positioned at suitable, different, heights with respect to the bottom of the liquid vessel 151. A lowest float switch 1581 is positioned nearest to the bottom. The lowest float switch 1581 provides an empty signal to the control device 157 when the liquid level A is at or below the lowest float switch 1581. In response to the empty signal, the control device 157 opens the control valve 1561 and automatically liquid is supplied to the vessel.

The float switch 1582 in the middle provides a full signal in case the liquid level A reaches the height of this flow switch 1582. The control device 157 closes the control valve 1561 in response to the full signal and thereby turns off the liquid supply.

A top float switch 1583 is positioned furthest away from the bottom. The top float switch 1583 provides an overfill signal to the control device 157 in case the liquid level A is at or above the top float switch 1581. In response to the overfill, the control device 157 shuts off the control valve 1531 of the gas outlet 153 to prevent leakage of the liquid into other parts of the lithographic projection apparatus 1.

A purge gas mixture with a relative humidity above or equal to 20%, such as equal to or more than 25%, provides particularly good results with respect to the performance of photo-resists. Furthermore, a purge gas mixture with a relative humidity equal or above 25% and below 70%, such as 60%, has a good preventive effect with respect to the accuracy of measurement systems in the lithographic projection apparatus. Furthermore, it was found that a humidity, e.g. about 40%, which is similar to the humidity in the space surrounding the lithographic projection apparatus, e.g., in the clean room, provides optimal results.

In some embodiments of the invention, for example where higher gas flow rates, improved vapor concentration control, or simplified operation are beneficial, a vaporizer can include a housing and a first region containing a purge gas flow and a second region containing a vaporizable liquid where the first and second regions are separated by a gas-permeable hollow fiber membrane that is substantially resistant to liquid intrusion. Such a vaporizer can be utilized to provide liquid vapor to a purge gas to form a purge gas mixture. In some embodiments the vaporizer is a moisturizer that includes a housing and a first region containing a purge gas flow and a second region containing water where the first and second regions are separated by a gas-permeable membrane that is substantially resistant to water intrusion.

Suitable materials for the vaporizer membranes include thermoplastic polymers such as poly (tetrafluoroethylene-co-perfluoro-3,6-dioxa-4-methyl-7-octene sulfonic acid) and perfluorinated polymers such as polytetrafluoroethylene. Non-wettable polymers, such as the perfluorinated polymers, are particularly preferred, especially polymers that are suitable for use with high pressure fluids and are substantially free of inorganic oxides (e.g., SOₓ and NOₓ, where x is an integer from 1-3). The membranes can be a sheet, which can be folded or pleated, or can be joined at opposite sides to form a hollow fiber. The hollow fiber membranes can be extruded porous hollow fibers in some versions of the invention. The membrane, in combination with any sealants, potting resin, or adhesives used to join the membrane to a housing, prevents liquid from permeating into a purge gas under normal operating conditions (e.g., pressures of 30 psig or less) and reduce or eliminate outgassing. The membrane is preferably configured to maximize the surface area of the membrane contacting the purge gas and a vaporizable liquid such as water and minimize the volume of the membrane. A moisturizer can contain more than one membrane per device, as described below.

A vaporizer with hollow fibers in a tube and shell configuration may be used. In some embodiments the vaporizer is used to add water vapor to a carrier gas and is can be called a moisturizer. For example, vaporizers or moisturizers having hollow fiber membranes typically include: a) a bundle of a plurality of gas-permeable hollow fiber membranes having a first end and a second end, where the membranes have an outer surface and an inner surface, with the inner surface encompassing one of the first and second regions; b) each end of the bundle potted with a liquid tight seal forming an end structure with a surrounding housing where the fiber ends are open to fluid flow; c) the housing having an inner wall and an outer wall, where the inner wall defines the other of the first and second regions between the inner wall and the hollow fiber membranes; d) the housing having a purge gas inlet connected to the purge gas source and a purge gas mixture outlet; and e) the housing having a vaporizable liquid inlet connected to the vaporizable liquid source and a vaporizable liquid outlet, wherein either the purge gas inlet is connected to the first end of the bundle and the purge gas mixture outlet is connected to the second end of the bundle or the vaporizable liquid inlet is connected to the first end of the bundle and the vaporizable liquid outlet is connected to the second end of the bundle. In some embodiments the vaporizable liquid is water.

Devices having hollow fiber membranes that are generally suitable for use as vaporizers or moisturizers are typically referred to as membrane contactors, and are described in U.S. Pat. Nos. 6,149,817, 6,235,641, 6,309,550, 6,402,818, 6,474,628, 6, 616,841, 6,669,177 and 6,702,941, the contents of which are incorporated herein by reference. Although many of the membrane contactors are described in the preceding patents as being useful for adding gas to or removing gas from a liquid (e.g., water), Applicants have discovered that membrane contactors can generally be operated as vaporizers such that vapor from a liquid is added to a purge gas flow with reduced or less than about 1 part per trillion added contaminants. The vaporizer in the purge gas mixture generator adds vapor to the purge gas at high flow rates while not contributing more than 1 part per trillion of contaminants to the purge gas. The vaporizer's effluent for example contains less than 1 ppt of non-methane hydrocarbons and less than 1 ppt of sulfur compounds. Suitable membrane vaporizers can be used downstream of a purifier without effecting the integrity of a purge gas formed by the purifier. Gas chromatography/pulsed flame ionization, APIMS, or other trace techniques can be used to characterize the cleanliness of the porous membrane vaporizers. Particular examples of membrane contactors which can be made and or treated to reduce contamination and made suitable for use as a moisturizer include the Infuzor® membrane contactor module marketed by Pall Corporation, Liqui-Cel® marketed by Membrana-Charlotte and Nafion® Membrane fuel cell humidifiers marketed by PermaPure LLC.

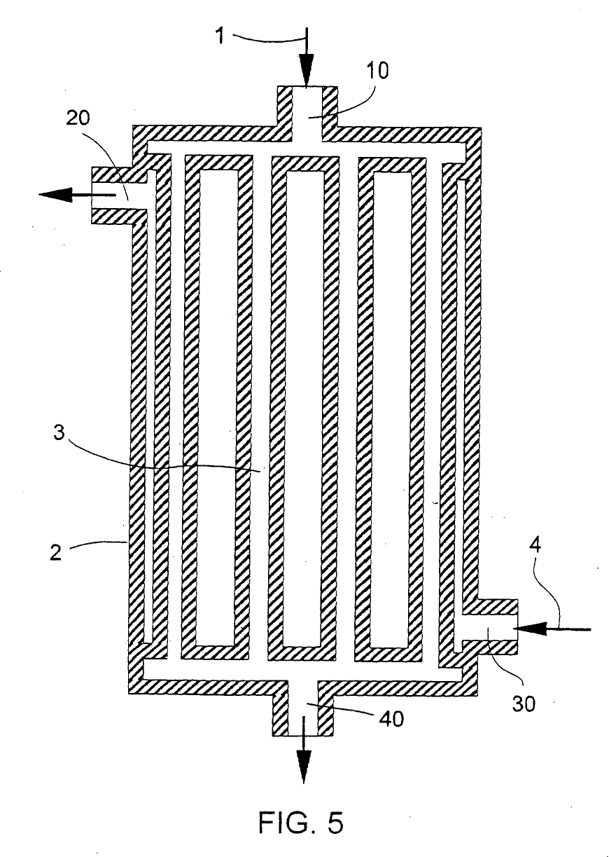

A schematic diagram of a particularly preferred vaporizer or moisturizer is shown in FIG. 5, the commercial embodiment of which is the pHasor® II Membrane Contactor, which is marketed by Mykrolis® Corporation of Billerica, Mass. As illustrated in FIG. 5, fluid 1 enters the moisturizer 2 through the fiber lumens 3, traverses the interior of the moisturizer 2 while in the lumens 3, where it is separated from fluid 4 by the membrane, and exits the contactor 2 through the fiber lumens at connection 40. Fluid 4 enters the housing through connection 30 and substantially fills the space between the inner wall of the housing and the outer diameters of the fibers, and exits through connector 20.

The gas-permeable hollow fiber membranes used in the versions of the vaporizer or moisturizer of the invention are typically one of the following: a) hollow fiber membranes having a porous skinned inner surface, a porous outer surface and a porous support structure between; b) hollow fiber membranes having a non-porous skinned inner surface, a porous outer surface and a porous support structure between; c) hollow fiber membranes having a porous skinned outer surface, a porous inner surface and a porous support structure between; or d) hollow fiber membranes having a non-porous skinned outer surface, a porous inner surface and a porous support structure between. These hollow fiber membranes can have an outer diameter of about 350 microns to about 1450 microns.

When these hollow fiber membranes are hollow fiber membranes having a porous skinned inner surface, a porous outer surface and a porous support structure between or hollow fiber membranes having a porous skinned outer surface, a porous inner surface and a porous support structure between, the porous skinned surface pores are preferably from about 0.001 microns to about 0.005 microns in diameter or their largest aspect. The pores in the skinned surface preferably face the liquid flow.

Suitable materials for these hollow fiber membranes include perfluorinated thermoplastic polymers such as poly (tetrafluoroethylene-co-perfluoro (alkylvinylether)) (poly (PTFE-CO-PFVAE)), poly (tetrafluoroethylene-co-hexafluoropropylene) (FEP) or a blend thereof, because these polymers are not adversely affected by severe conditions of use. PFA Teflon® is an example of a poly (PTFE-CO-PFVAE)) in which the alkyl is primarily or completely the propyl group. FEP Teflon® is an example of poly (FEP). Both are manufactured by DuPont. Neoflon™ PFA (Daikin Industries) is a polymer similar to DuPont's PFA Teflon®. A poly (PTFE-CO-PFVAE) in which the alkyl group is primarily methyl is described in U.S. Pat. No. 5,463,006, the contents of which are incorporated herein by reference. A preferred polymer is Hyflon® poly (PTFE-CO-PFVAE) 620, obtainable from Ausimont USA, Inc., Thorofare, N.J. Methods of forming these polymers into hollow fiber membranes are disclosed in U.S. Pat. Nos. 6,582,496 and 4,902,456, the contents of which are incorporated herein by reference.

Potting is a process of forming a tube sheet having liquid tight seals around each fiber. The tube sheet or pot separates the interior of the moisturizer from the environment. The pot is thermally bonded to the housing vessel to produce a unitary end structure. A unitary end structure is obtained when the fibers and the pot are bonded to the housing to form a single entity consisting solely of perfluorinated thermoplastic materials. The unitary end structure comprises the portion of the fiber bundle which is encompassed in a potted end, the pot and the end portion of the perfluorinated thermoplastic housing, the inner surface of which is congruent with the pot and bonded to it. By forming a unitary structure, a more robust vaporizer or moisturizer is produced, less likely to leak or otherwise fail at the interface of the pot and the housing. Moreover, forming a unitary end structure avoids the need to use adhesives such as epoxy to bond the fibers in place. Such adhesives typically include volatile hydrocarbons, which contaminate the purge gas flowing through the vaporizer or moisturizer. For example, purge gas humidified using a Liqui-cel moisturizer marketed by Perma Pure noticeably smelled of epoxy, which clearly indicates an unacceptable hydrocarbon content in the purge gas, likely in the hundreds of ppm. The potting and bonding process is an adaptation of the method described in U.S. Application No. 60/117,853 filed Jan. 29, 1999 and is disclosed in U.S. Pat. No. 6,582,496, the teachings of which are incorporated by reference. The bundles of hollow fiber membranes are preferably prepared such that the first and second ends of the bundle are potted with a liquid tight perfluoronated thermoplastic seal forming a single unitary end structure comprising both the first and second ends with a surrounding perfluorinated thermoplastic housing where the fibers of the ends are separately open to fluid flow.

One version of the invention is an apparatus that adds vapor to a purge gas. The apparatus can comprise a source gas inlet in fluid communication with one or more regenerable purifiers and a purge gas outlet from the purifiers in fluid communication with a purge gas inlet of a vaporizer. The purifiers can be independently regenerable and remove contaminants from the source gas inlet to the purifiers to form a purge gas. The vaporizer can comprise a housing and one or more microporous hollow fiber membranes. The housing has a purge gas inlet and a purge gas mixture outlet in fluid communication with a first side of the microporous hollow fibers. The housing has an inlet for a vaporizable liquid and an outlet for a vaporizable liquid in fluid communication with a second side of the microporous hollow fibers. The microporous hollow fiber membranes contribute less that 1 part per billion of contaminants that degrade the optical properties of optical components in a lithographic projection system, and in some embodiments less than one hundred parts per trillion of such volatile contaminants, to a vapor from a vaporizable liquid the vaporizer. The vaporizer may be cleaned or treated to reduce or remove such contaminants. The microporous hollow fibers are resistant to liquid intrusion by the vaporizable liquid.

The apparatus can further include a temperature regulation system that maintains the temperature of the vaporizer, the purge gas inlet, the purge gas mixture outlet, or a combination of these within one or more setpoint ranges. The temperature regulation system can include one or more temperature measuring devices, one or more heat exchangers that can modify the temperature of one or more zones or regions of the apparatus and a controller. The controller receives temperature input from the temperature measuring devices and modifies the temperature of the apparatus by controlling the operation of the one or more heat exchangers. The heat exchangers may include but are not limited to heaters, chillers, peltier coollers, fans or other devices. The temperature regulation system can maintain the temperature of the vaporizers, the purge gas, the purge gas mixture or any combination of these to a setpoint temperature within a temperature range of about ±5° C. or less, in some embodiments±1° C. or less, and is still other embodiments ±0.5° C. or less. The temperature regulation system can maintain the purge gas mixture to a temperature above the condensation temperature of the vapor such that vapor condensation is reduced or eliminated. In some embodiments the temperature regulation system can maintain the temperature of the vapor in the purge gas mixture above the condensation temperature of the vapor to within a temperature range of about ±1° C. or less. The temperature regulation system can maintain the temperature of the apparatus such that the concentration of vapor in the purge gas, the purge gas mixture, has a concentration that varies by less than 5%, in some embodiments less than 1%, and in still other versions less than 0.5%. The temperature regulation system can maintain a temperature gradient in the apparatus. By maintaining the temperature of the apparatus, the temperature regulation system provides an essentially constant vapor concentration. In some versions the temperature regulation system maintains the temperature of the purge gas mixture at an essentially constant temperature at different purge gas flow rates.

The apparatus can include a pressure regulation system that maintains the pressure of the vaporizable liquid, the pressure of a purge gas, or any combination of these to prevent the formation of purge gas bubbles in the vaporizable liquid in the microporous hollow fibers and provide a vapor concentration in the purge gas mixture that varies by less than 5%, in some embodiments less than 1%, and in still other versions less than 0.5%. The pressure regulation system can include a pressurized source of vaporizable fluid whose feed pressure can be modified for example by a pressurized gas or a pump. The pressure regulation system can include pressure transducers, metering valves, and a controller to measure and modify the pressure of the vaporizable liquid on one side of the hollow fiber porous membranes in the vaporizer. The pressure regulation system can include one or more pressure transducers, metering valves, and a controller to measure and modify the pressure of the purge gas or purge gas mixture in contact with a second side of the porous hollow fibers in the vaporizer. The pressure regulation system can maintain a pressure of the purge gas or purge gas mixture and prevent the formation of purge gas bubbles in the vaporizable liquid. In some versions of the apparatus the pressure regulation system maintains the vaporizable liquid pressure about 5 psi or more above the pressure of the purge gas. The pressure regulation system can include a pressure controller and a back pressure regulator.

The apparatus in embodiments of the present invention can include a flow control system that maintains the flow rate of purge gas, a dilution gas, the flow rate of purge gas mixture from the apparatus, or any combination of these. The flow control system can include one or more mass flow controllers, one or more vapor concentration sensors, and a controller. Based on a vapor concentration or fraction of vapor saturation setpoint, the controller can take the concentration output from the vapor sensors and modify the mixture of purge gas and purge gas mixture to produce a diluted purge gas mixture that has a desired or setpoint concentration of vapor. The flow control system can provide a vapor concentration in the purge gas mixture that varies by less than 5%, in some embodiments less than 1%, and in still other versions less than 0.5%.

The apparatus can make a purge gas mixture or a diluted purge gas mixture that has less than 1 part per billion, and in some versions less than 1 part per trillion of volatile impurities. In some versions of the invention, the purge gas mixture can be formed at a purge gas flow rate of greater than about 20 slm with the amount of liquid vapor in the purge gas mixture from the vaporizer being greater than about 20% of the amount of vapor that would saturate the purge gas at the temperature and pressure of the lithographic projection system or other delivery point. The composition or concentration of vapor in the purge gas mixture can be modified by controlling the temperature, pressure, flow, or any combination of these in the apparatus. The concentration of vapor in the purge gas mixture can be further modified by dilution with additional purge gas by the step or act of mixing purge gas with the purge gas mixture from the purge gas mixture outlet of the vaporizer. The purge gas mixture or diluted purge gas mixture can be further treated by the act of passing the vapor containing purge gas mixture through a liquid trap and removing liquid.

The vaporizable fluid can be fed to the hollow fibers from a pressurized source using a metering valve. Optionally the vaporizable fluid can be fed into the vaporizer with vaporizable liquid flowing in a re-circulation loop or a dead end feed. For example, the vaporizable liquid may be in a temperature controlled vessel and fed by a pump into the vaporizer and any remaining vaporizable liquid returned to the vessel for further heating. In some versions the outlet of the liquid side of the contactor can be closed and vaporizable fluid fed to the vaporizer from a pressurized source as it is vaporized by the purge gas.

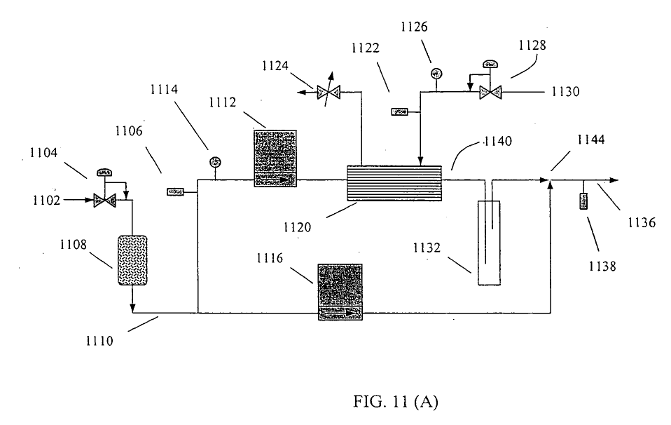

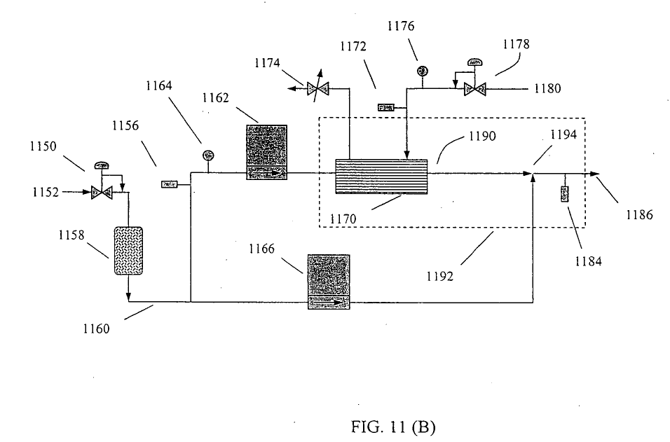

FIG. 11 (A) schematically illustrates a purge gas mixture supply system that further conditions a gas 1102 from a source (not shown but could be a house nitrogen supply, electronic grade gas from a cylinder, or the like) through a regulator 1104 and into purifier 1108 to produce a flow of a purge gas 1110 that can be controlled by mass flow controllers 1112 and 1116. The purifier 1108 can include one or more independent and separately regenerable purifiers. Optional pressure transducer 1114, temperature transducer 1106, and vapor sensor (not shown) can also be present. A non-contaminating vaporizable liquid 1130 whose vapor can be used to control, enhance, or modify the activity of a photoresist, other lithographic chemical coating, or other substrate coating can be supplied to the vaporizer or contactor 1120 from a source (not shown). For example, a vaporizable liquid like water 1130 from a source (not shown) can flow through pressure regulator 1128, through the vaporizer or moisturizer 1120, and through optional flow control valve 1124. The vapor in the purge gas enhances the activity of the photoresist compared to a purge gas absent the vapor; by maintaining the vapor concentration in the purge gas, the purge gas mixture can be used to control the photoresist activity. Optional pressure transducer 1126 and temperature transducer 1122 are also shown. The water 1130 can flow in a counter current direction to the direction of purge gas flow 1110 which is illustrated as moving from mass flow controller 1112 through the moisturizer 1120. In some versions the water and gas can flow in the same direction. Purge gas 1110 from mass flow controller 1112 picks up liquid vapor through the porous membrane that resists liquid intrusion in the moisturizer 1120 to form a purge gas mixture 1140. The purge gas can be fed and used in a lithographic projection system connected to outlet 1136. The purge gas mixture 1140 can optionally be mixed and diluted with the purge gas from a second mass flow controller 1116 to form a diluted purge gas mixture 1144 that can be fed and used in a lithographic projection system connected to outlet 1136. This dilution can be used to maintain a constant flow of purge gas from mass flow controller 1112 through the vaporizer 1120 and can aid in temperature control of the vaporizer 1120. An optional trap 1132, whose position in the apparatus can be varied, can be used to remove any droplets of liquid or condensation from the moisturizer 1120. The trap can be a particle filter or a liquid trap and its position chosen to provide reduction in liquid or particle drops. A vapor sensor 1138 can optionally be positioned downstream of the vaporizer 1120. Optionally a controller can be used to receive the output of the vapor sensor 1038 and modify the purge gas flow 1110 through mass flow controller 1116 to modify or maintain the concentration of vapor in the diluted purge gas mixture 1144. In some versions the vapor sensor is a moisture sensor. The purge gas mixture 1144 can be provided at an outlet 1136 for use in a lithographic projection system or other system that utilizes purging with a purge gas mixture.

FIG. 11 (B) illustrates a purge gas mixture supply system that further conditions a gas 1152 from a source (not shown but could be a house nitrogen supply, electronic grade gas cylinder, a gas generator, or the like) through a regulator 1150 and into purifier 1158 to produce a purge gas flow 1160 that flows to mass flow controllers 1162 and 1166. The purifier 1158 can include one or more independent and separately regenerable purifiers. One or more optional pressure transducers 1164, temperature transducer 1156, vapor sensor (not shown) can be positioned before the vaporizer 1170. A non-contaminating vaporizable liquid 1180, for example water, from a source (not shown) can flow through pressure regulator 1178, through the contactor or moisturizer 1170, and through optional flow control valve 1174. Optional pressure transducer 1176 and temperature transducer 1172 are also shown. As shown, the vaporizable liquid can flow in a counter current direction to the direction of purge gas flow 1160 from mass flow controller 1162 through the contactor 1170. Purge gas from mass flow controller 1162 takes up liquid vapor through the porous membrane to form a purge gas mixture 1190. The purge gas mixture 1190 can optionally be mixed and diluted with the purge gas 1160 from a second mass flow controller 1166 to form a diluted purge gas mixture 1194. This dilution can be used to maintain a constant flow of purge gas through the vaporizer 1170 and can aid in temperature control of the vaporizer. FIG. 11(B) illustrates a heat exchanger or temperature controlled environment 1192 that can be used to maintain the temperature of the generated purge gas mixture 1194 in a temperature range that avoids condensation of vapor in the purge gas mixture 1190. This temperature is above the condensation point of the vapor in the purge gas mixture. For example, if the partial pressure of water is close to the saturation pressure, it may only take a slight drop in temperature for the water vapor to convert to its liquid phase. The temperature control environment 1192 can also be used to maintain the temperature of the liquid in the contactor and thereby maintain the concentration of vapor from the vaporizer 1170 to a range that can be used to provide the proper reactivity of a photoresist, or other patterned coating on a substrate. For example, a temperature conditioned purge gas mixture with water vapor can be provided at purge gas mixture outlet 1186 for use in the illumination optics and or projection lens PL of a lithographic projection apparatus of FIG. 2. The purge gas mixture can be provided at outlet 1186 with or without dilution by purge gas 1160 from mass flow controller 1166.

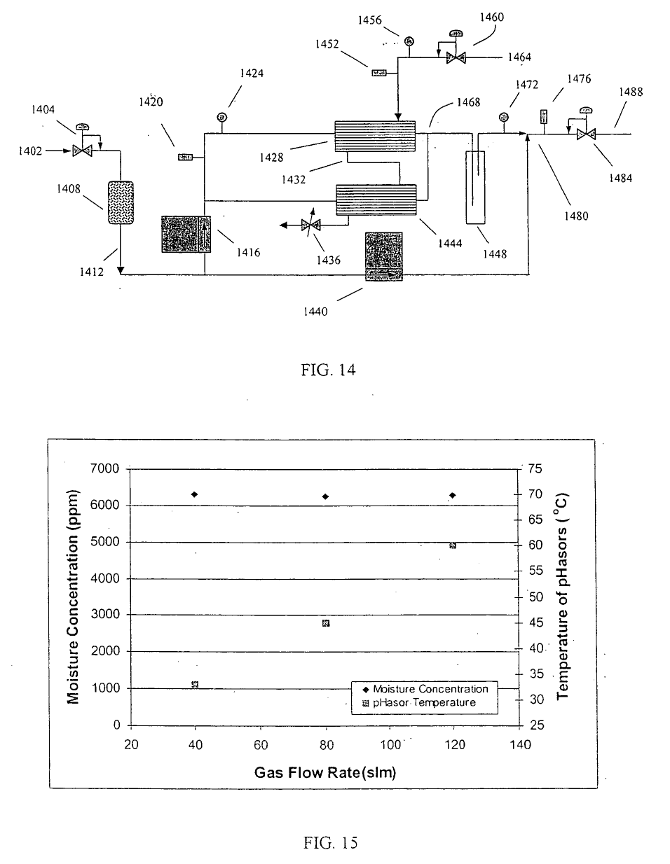

FIG. 14 schematically illustrates a purge gas mixture supply system that further conditions a gas 1402 from a source (not shown) through a regulator 1404 and into purifier 1408 to produce a purge gas 1412 that flows into mass flow controllers 1416 and 1440. The purifier 1408 can include one or more independent and separately regenerable purifiers. Optional pressure transducer 1420, temperature transducer 1424, and vapor sensor (not shown) can also be present. A vaporizable liquid composition 1464 that can be used to control the activity of a photoresist, or other lithographic chemical coating can be supplied from a source (not shown) to one or more vaporizers 1428 and 1432. As shown in FIG. 14, one or more vaporizers 1428 and 1444 may be configured in a parallel relationship. Alternatively the contactors can be connected in a series configuration. For example, a vaporizable liquid like water 1464 from a source can flow through pressure regulator 1460, through the vaporizer or moisturizers 1428 and 1444 interconnected by conduit 1432, and through optional flow control valve 1436. Optional pressure transducer 1456 and temperature transducer 1452 can also be used. The liquid 1464 through the vaporizers 1428 and 1444 can flow in a counter current direction to the direction of purge gas 1412 from mass flow controller 1416. Purge gas 1412 from mass flow controller 1416 picks up vapor from the vaporizable liquid through the porous membrane in the vaporizers 1428 and 1444 to form a purge gas mixture 1468. The porous membranes resist liquid intrusion. The purge gas can be fed and used in a lithographic projection system connected to outlet 1488. The purge gas mixture 1468 can optionally be mixed and diluted with the purge gas 1412 from a second mass flow controller 1440 to form a diluted purge gas 1480 that can be fed and used in a lithographic projection system connected to outlet 1488. This dilution can be used to maintain a constant flow of purge gas from mass flow controller 1412 through the one or more vaporizers 1428 and 1444 which can aid in temperature control of the vaporizers. An optional trap 1448, whose position can in the manifold can be varied, may be used to remove any droplets of liquid or condensation from the vaporizers. The trap can be a particle filter or a liquid trap. A vapor sensor 1478 can optionally be positioned downstream of the vaporizers. Optionally the output of the vapor sensor 1478 can be configured with mass flow controller 1440 and a controller to vary the flow of purge gas 1412 through mass flow controller 1440 to modify or maintain the concentration of vapor in the diluted purge gas mixture 1480. Purge gas mixture 1480 can be provided at an outlet 1488 for use in a lithographic projection system or other system that utilizes purging with a purge gas mixture.

Purge gas mixture supply systems are typically capable of operation at a purge gas flow rate of at least about 30 standard liters per minute. The temperature of the apparatus can be chosen such that the temperature of the vaporizable fluid has a viscosity that prevents liquid intrusion of the membrane at the intended operating pressure and has a vapor pressure sufficient to provide sufficient vapor for the purge gas mixture at the operating flow rate. In some embodiments the temperature of the apparatus is about room temperature, in some embodiments above about 25° C., in some embodiments at least about 30° C., in some embodiments about 35° C., in some embodiments at least about 50° C., in some embodiments at least about 60° C., and in still other embodiments at least about 90° C. Flow rates of purge gas through the vaporizer or moisturizer can be at least about 20 standard liters per minute (slm), in some embodiments at least about 60 slm, and in some other embodiments at least about 120 slm.

In some versions of the invention where the purge gas mixture contains water vapor exiting the vaporizer, the purge gas can have a relative humidity of at least about 20%. Higher relative humidity values of at least about 50%, at least about 80%, at least about 90%, at least about 98%, or about 100% (to produce a substantially saturated purge gas) are possible, depending upon the conditions under which the moisturizer is operated. For example, higher stabilized relative humidity values are reached by lengthening the time a purge gas resides in the moisturizer (e.g., by reducing the flow rate or increasing the size of the moisturizer) or heating the moisturizer or at least the water in the moisturizer. The purge gas pressure and flow of water across the vaporizer membrane can be modified to alter the amount of water vapor in the purge gas. In particular, lowering the pressure of the purge gas results in increased humidification of the purge gas. When the purge gas pressure is decreased, the need to heat the water to obtain a high relative humidity is lessened.

As with the moisturizer shown in FIG. 4, the moisturizer device of FIG. 5 can be provided with a control device via which the amount of moisture in the purge gas mixture can be controlled. The control device is connected with a moisture control contact to a control valve via which the flow rate of unhumidified purge gas supplied (e.g., direct from the purge gas source) to a mixing chamber with humidified purge gas exiting the moisturizer of FIG. 5 can be controlled. This is illustrated for example in FIG. 11(A).

In some embodiments the vaporizer in the purge gas mixture generator adds vapor to the purge gas at high flow rates while not contributing contaminants to the purge gas. Contaminants can be characterized as those materials, atoms, or molecules that have an adverse effect on or result in degradation or uncontrolled modification the optical properties of optical components interacting with the radiation to form a pattern on a substrate in a lithographic projection apparatus. Versions of the invention provide a purge gas with less than about 1 part per billion of contaminants that interact and degrade or modify the optical properties of the optical components, in other versions the purge gas contains less than about 100 parts per trillion of these contaminants, in still other versions less than about 1 part per trillion of these contaminants. Optical components can include but are not limited to mirrors, lenses, beam splitters, gratings, pellicle, reticle, or other optical components that interact with the patterning beam, or combinations of these. The contaminants may further be characterized as those that form a sub-monolayer or more, a monolayer or more, about 10 to about 50 monolayers, or thicker films resulting from the contaminants interacting with the optical components, such as by adsorption, chemisorption and/or physisorption, chemical reaction, chemical reaction by interaction with the radiation beam, or any combination of these. The films modify or degrade the transmission, reflection, refraction, depth of focus, or absorption of the radiation that interact with the component requiring in a change in process parameters or replacement of the element to maintain the yield of the lithographic process. The amount of these contaminants may be determined by changes in the optical properties of the optical components with time or by other methods such as thermal desorption and GC/mass spectroscopy, time of flight SIMs, or the accumulation of these contaminants may be determined by surface acoustic wave or other piezoelectric sensors.

Purge gas mixture generators of the invention can be treated to reduce volatile contaminants. For example, the vaporizers, moisturizers, and other fluid contacting surface can be heated for a sufficient length of time at a temperature sufficient to substantially remove compounds that volatilize at temperatures of about 100° C. or less. The vaporizers may be contacted with chemically compatible acids, bases, a oxidizers, or a combination of these, for example high purity hydrogen peroxide or ozone gas, to decompose and remove residue from the vaporizer. These treatments allow vaporizer use their use in applications where essentially contaminant-free gas is required. For purposes of the present invention, a purge gas is defined as a gas or a mixture of gas having contaminant levels of no greater than about 1 ppb. Purge gases include inert gases such as nitrogen and argon, along with oxygen-containing gases/such as compressed dry air and clean dry gas. An appropriate purge gas is determined relative to the intended application, such that non-inert gases such as oxygen are not contaminants in certain uses but are considered contaminants in other uses. Preferably, the purge gas mixture generators (and vaporizers or moisturizers) do not contribute contaminants to a purge gas. Examples of contaminants may include hydrocarbons, NOₓ, SOₓ, or others. For example, a purge gas containing no greater than about 1 ppb (or about 1000 parts per trillion (ppt)) of contaminants exits the moisturizer as a humidified purge gas containing no greater than about 1 ppb (or 1000 ppt) of contaminants. It has been found that a particular moisturizer of the invention (see Example 1) is capable of humidifying a purge gas, such that contaminant levels remain less than 1 ppt.

The liquid that is vaporized into the purge gas can be used to maintain or enhance the activity of chemicals used in the lithographic process. The liquid water used in the moisturizer to form water vapor for the purge gas mixture contributes 1 part per billion or less of contaminants to the purge gas mixture. In some versions the water used in the moisturizer to form water vapor for the purge gas mixture contributes 1 part per billion or less of contaminants that have an adverse affect on optical properties of optical components in a lithographic projection system. The water can be but is not limited to ultra high purity water. UHP water can be obtained from water sources of the such as but not limited Millipore® MilliQ® water which can optionally be distilled and or filtered. The flow rate of a vaporizable liquid, for example water through the vaporizer can be about 0 ml/hr or higher; such low flows may occur where a static pressure is used to make up water removed by the purge gas (dead end flow). The flow rate of vaporizable liquid through the vaporizer can be about 100 ml/hr or higher in some versions, and can be about 300 ml/hour or higher in other versions. The flow rate of a vaporizable liquid such as water can be adjusted to minimize the amount of vaporizable liquid used, the flow can be adjusted to maintain the temperature of vaporizable liquid in the moisturizer, the flow can be adjusted to make up for vaporized liquid taken up by the purge gas, or any combination of these.

### EXAMPLE 1

A Mykrolis pHasor® II membrane contactor was tested as a vaporizer for the release of non-methane hydrocarbon and sulfur compounds. A membrane contactor that does not release contaminants may be used for moisture addition to an XCDA® gas stream (less than 1 part-per-trillion (ppt) for hydrocarbon and sulfur compounds).

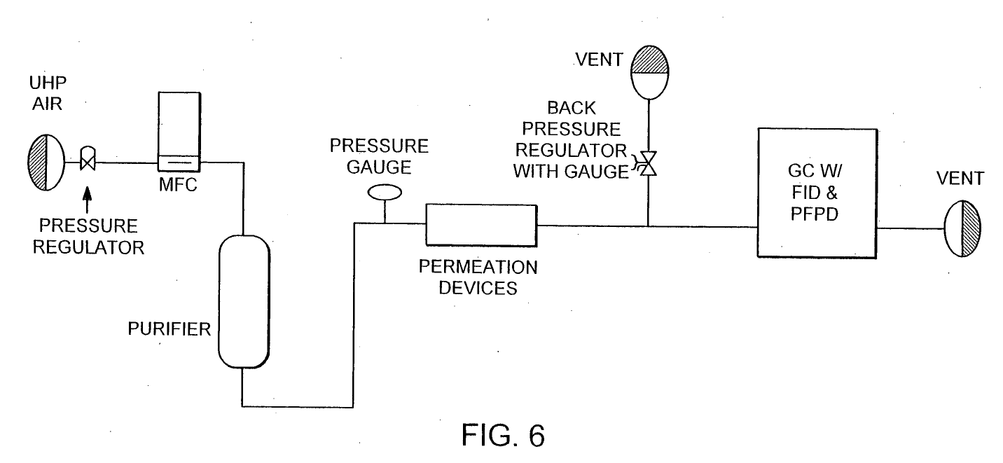

The pHasor® II was cleaned to remove volatile compounds. FIG. 6 represents the experimental setup for measuring contaminants in the humidified purge gas from the pHasor® II. A pressure regulator was used to maintain the pressure of the gas upstream of the mass flow controller (MFC). An MFC was used to maintain the flow rate of the air through the lumen side of the pHasor® II. A purifier was used to remove contaminants from the gas upstream of the pHasor® II to produce an XCDA purge gas. A pressure gauge upstream of the pHasor® II was used to monitor the inlet pressure. A backpressure regulator was used to maintain the outlet pressure of the pHasor® II. The shell side of the pHasor® II was not filled with water. The water was removed from the pHasor® II during this test since high concentrations of moisture will destabilize the detectors. A Gas Chromatograph with a Flame Ionization Detector and Pulsed Flame Photometric Detector (GC/FID/PFPD) was used to measure the concentration of hydrocarbons and sulfur compounds in the pHasor® II's effluent. A cold trap method was used to concentrate hydrocarbon and sulfur compounds, which reduces the lower detection limit to 1 ppt concentration levels.

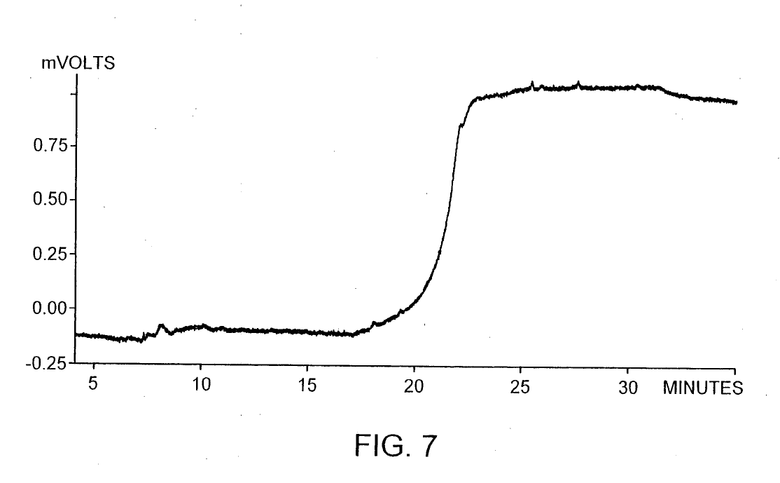

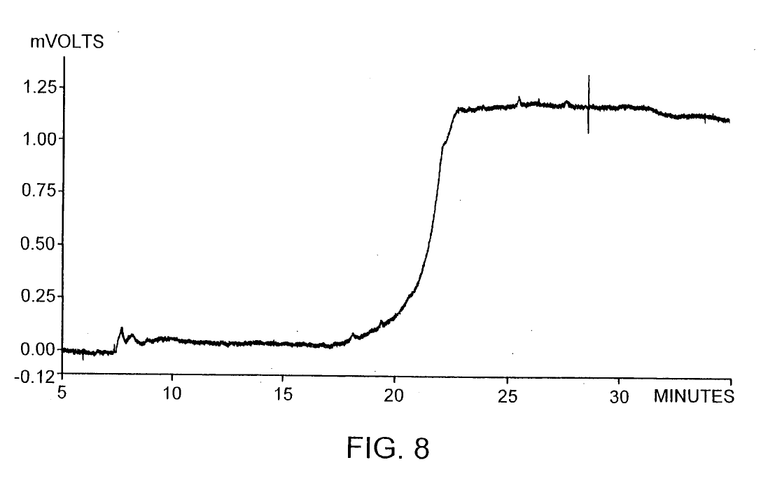

FIG. 7 represents a clean background reading of less than 1 ppt of hydrocarbon contaminants using the GC/FID. FIG. 8 represents the GC/FID reading downstream of the pHasor® II. As shown, both readings are basically identical. Therefore, the less than 1 ppt of hydrocarbon contamination concentration is maintained when XCDA® is flowing through a pHasor® II.

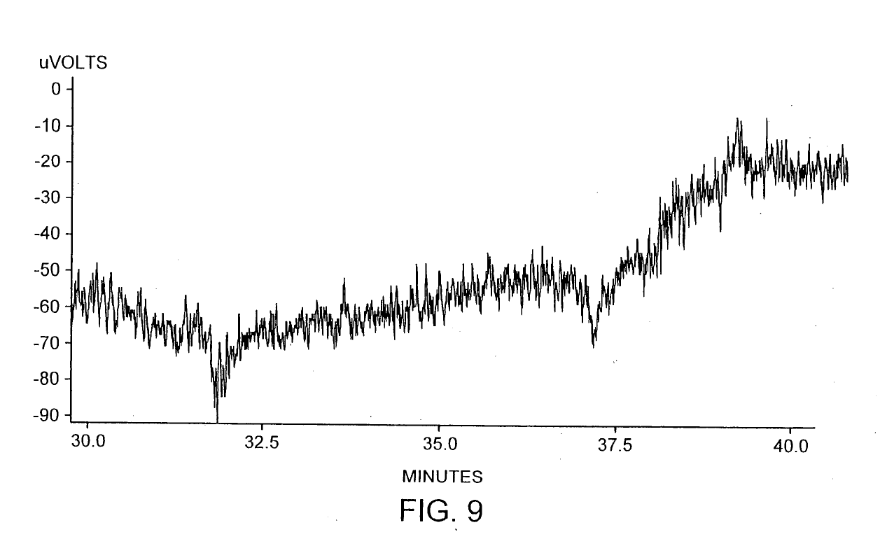

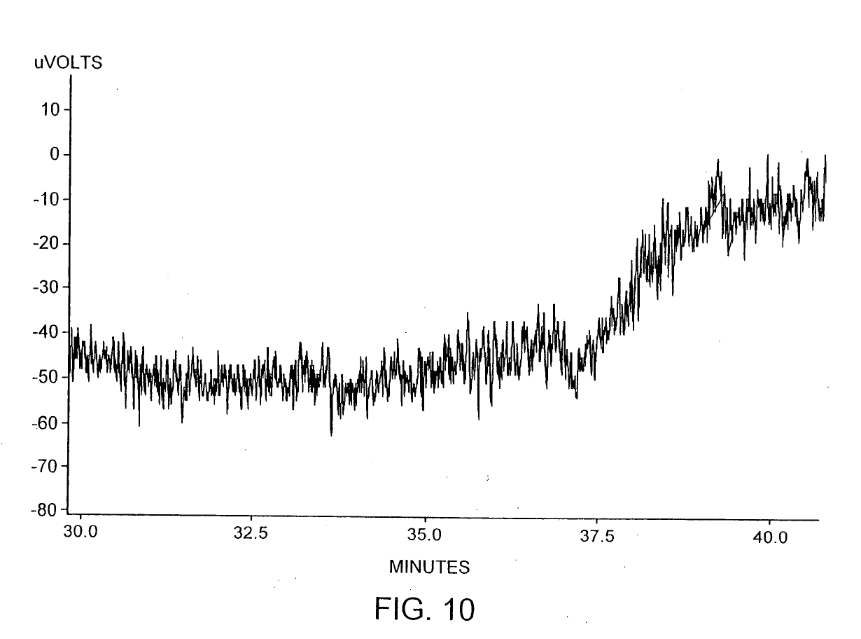

FIG. 9 represents a clean background reading of less than 1 ppt of sulfur contaminants using the GC/PFPD. FIG. 10 represents the GC/PFPD reading downstream of the pHasor® II. As shown, both readings are basically identical. Therefore, the less than 1 ppt concentration for sulfur contamination is maintained when XCDA® is flowing through a pHasor® II.

The pHasor II's effluent contains less than 1 ppt of non-methane hydrocarbons and less than 1 ppt of sulfur compounds. Therefore, the pHasor II can be used downstream of a purifier without effecting the integrity of a XCDA purge gas.

### EXAMPLE 2

An Entegris Inc. pHasor® II membrane contactor was used to humidify clean dry air (CDA) using varied water temperatures, CDA flow rates and CDA pressures. For all experiments, the pHasor® II was cleaned to remove volatile compounds. An MFC was used to maintain the flow rate of the air through the lumen side of the pHasor® II. Deionized water was used as a vaporizable liquid in the shell side of the pHasor® II, which was heated using a heat exchanger. Water flow was controlled using a regulator on the outlet side of the pHasor. Water temperature was measured on the liquid inlet and outlet sides of the pHasor II and purge gas pressure, temperature and relative humidity were measured on the lumen outlet side of the pHasor II.

In the first experiment, the temperature of the water was varied for different flow rates of CDA. The CDA used for this experiment had a back pressure of 20 psi, an initial temperature of 19° C. and a relative humidity of 6%. The house deionized water flowed through the pHasor® II at a rate of 160 mL/min. The results of the first experiment are shown in Tables 1-3:

TABLE 1
Humidification of CDA Having 40 SLM Flow Rate

| Water Temp. (° C.) | Relative Humidity (%) | Outlet Gas Temp(° C.) |
|---|---|---|
| 24 | 42 | 20 |
| 27 | 49 | 20 |
| 30 | 52 | 21 |
| 33 | 60 | 21 |
| 36 | 68 | 23 |
| 39 | 83 | 22 |
| 41 | 92 | 23 |
| 42 | 98 | 23 |

TABLE 2
Humidification of CDA Having 70 SLM Flow Rate

| Water Temp. (° C.) | Relative Humidity (%) | Outlet Gas Temp(° C.) |
|---|---|---|
| 24 | 40 | 21 |
| 27 | 44 | 21 |
| 30 | 47 | 22 |
| 33 | 58 | 22 |
| 36 | 60 | 24 |
| 39 | 75 | 23 |
| 41 | 81 | 24 |
| 42 | 90 | 24 |

TABLE 3
Humidification of CDA Having 100 SLM Flow Rate

| Water Temp. (° C.) | Relative Humidity (%) | Outlet Gas Temp(° C.) |
|---|---|---|
| 24 | 40 | 20 |
| 27 | 40 | 21 |
| 30 | 41 | 22 |
| 33 | 46 | 23 |
| 36 | 50 | 24 |
| 39 | 55 | 25 |
| 41 | 62 | 26 |
| 42 | 65 | 26 |

In the second experiment, the back pressure of CDA in the pHasor II was varied. The CDA used for this experiment had an initial temperature of 19° C. and a relative humidity of 1%. The house deionized water was heated to 35° C. and flowed through the pHasor II at a rate of 156 mL/min. The results of the first experiment are shown in Tables 4-6:

TABLE 4
Humidification of CDA having 50 SLM Flow Rate

| CDA Pressure (psig) | Relative Humidity (%) | Temperature (° C.) |
|---|---|---|
| 10 | 98 | 23 |
| 15 | 80 | 23 |
| 20 | 63 | 23 |
| 25 | 55 | 23 |

TABLE 5
Humidification of CDA having 70 SLM Flow Rate

| CDA Pressure (psig) | Relative Humidity (%) | Temperature (° C.) |
|---|---|---|
| 5 | 98 | 24 |
| 10 | 88 | 23 |
| 15 | 74 | 23 |
| 20 | 60 | 22 |
| 25 | 51 | 22 |

TABLE 6
Humidification of CDA Having 100 SLM Flow Rate

| CDA Pressure (psig) | Relative Humidity (%) | Temperature (° C.) |
|---|---|---|
| 5 | 68 | 26 |
| 10 | 68 | 24 |
| 15 | 60 | 24 |
| 20 | 51 | 24 |
| 25 | 46 | 24 |

The first experiment demonstrates that humidification of a purge gas increases as the water temperature increases. The most significant increases in relative humidity of CDA were observed when the water temperature was 30° C. or greater. Water temperature has a lesser effect on humidification at temperatures of less than 30° C.

The second experiment demonstrates that a purge gas is more rapidly saturated with moisture when the back pressure of purge gas in a membrane contactor is decreased. This effect is roughly linear over the pressure range tested.

### EXAMPLE 3

The purpose of the experiment was to determine the water vapor output of a microporous hollow fiber polymeric membrane based vaporizer at various flow rates and pressures.

A modified version of the manifold illustrated in FIG. 11(A) was used. The manifold included a gas mass flow controller (MFC) that was used to maintain the flow rate of nitrogen through the lumens of a pHasor® II hollow fiber contactor available from Entrgris Inc. An Aeronex SS-500KF-I-4R purifier removed moisture from the house nitrogen upstream of the pHasor® II. A Kahn Moisture Probe was used to monitor the moisture upstream of the pHasor® II (not shown in FIG. 11(A)). The pHasor® II was used for moisture addition by allowing water vapor to diffuse from the shell side of the microporous membrane, through the lumens, and into the gas stream. The gas pressure was controlled to within about 5 pounds per square inch (psig) of the water pressure to prevent purge gas from creating bubbles in the water stream. A pressure gauge and thermocouple were used to monitor the pressure and temperature upstream of the pHasor® II. The flow rate of de-ionized water was maintained through the shell side of the pHasor® II at 100 milliliters per hour with a needle valve. Pressure gauges were used to measure the pressure of the water upstream and downstream of the pHasor® II. A thermocouple measured the water temperature downstream of the pHasor® II. The pHasor® II's temperature was maintained at 25° C. with an Omega Silicone Heater. A Mykrolis Thermogard™ and Wafergard® II were placed within the test manifold downstream of the pHasor® II to remove any droplets of moisture. A Vaisala Moisture Probe was used to measure the relative humidity and temperature downstream of the pHasor® II. An AP Tech backpressure regulator was used to maintain the pressure downstream of the pHasor® II (not shown in FIG. 11(A)).

A vessel was filled with water and pressurized with gas to provide high pressure water to the pHasor® II. The pressure of water was varied from 18 to 59 psig. A valve to the pHasor® II was opened to allow water to flow through the shell side of the vaporizer at a set pressure.

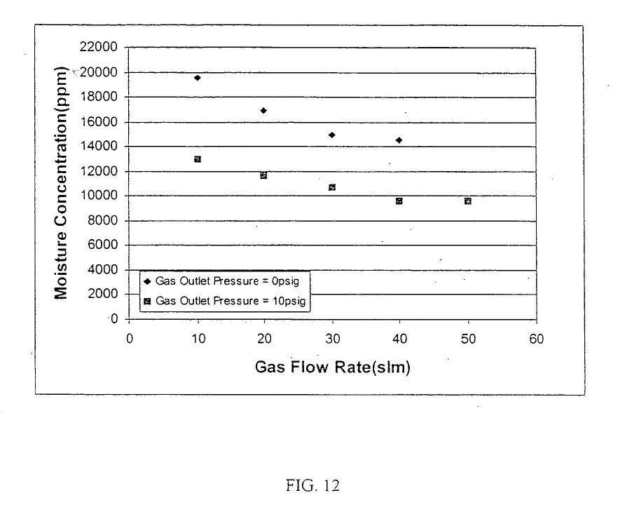

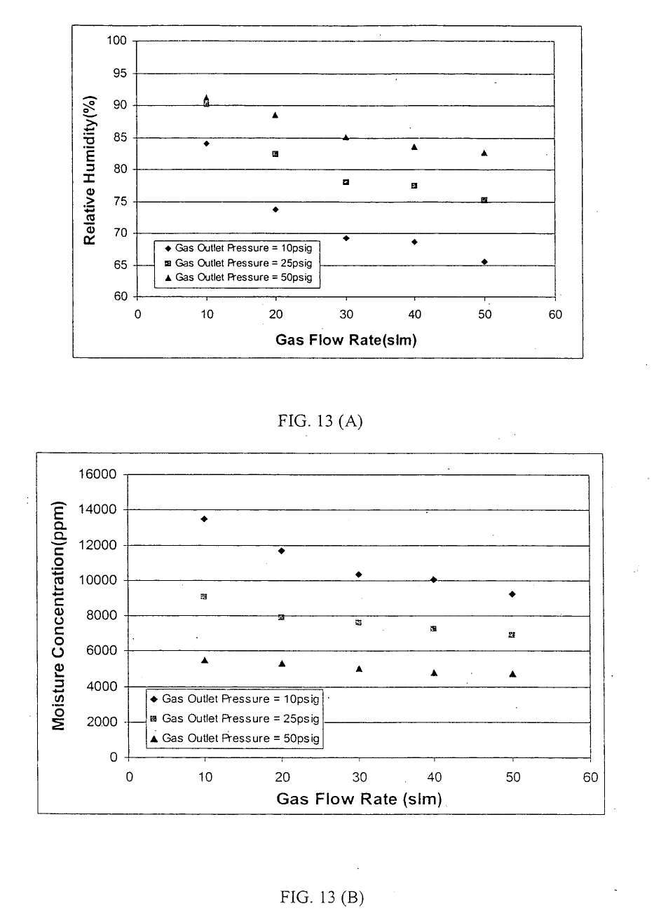

FIG. 12 illustrates the results of tests where the moisture concentration in the purge gas generated by the pHasor® II varied at different purge gas flow rates (10, 20, 30, 40, and 50 slpm) at two different gas outlet gas pressures (0 and 10 psig) with the liquid water pressure at 18 psig. It was observed that moisture concentration of the purge gas mixture decreased with an increase in purge gas flow rate for the two gas outlet pressures. It was also observed that as the gas outlet pressure approached the liquid pressure, for example the 10 psig gas outlet pressure, the concentration of moisture in the gas for a given flow rate and temperature decreased. FIG. 13(A) illustrates the results of tests measuring the relative humidity in the generated purge gas mixture at different flow rates (10, 20, 30, 40, and 50 slpm) and different gas pressures (10, 25, and 50 psig) for water on the shell side of the moisturizer at 59 psig. The results show that relative humidity decreases with increasing flow rate and the relative humidity in the purge gas mixture decreases with decreasing outlet pressure. FIG. 13(B) illustrates the relative humidity data from FIG. 13(A) converted into moisture concentration in parts per million (ppm). The results show in FIG. 13(B) show that the moisture concentration decreases with increasing gas flow rate. The results show in FIG. 13(B) also show that as the gas outlet pressure approached the liquid pressure, the concentration of moisture in the gas for a given flow rate and temperature decreases.

Relative humidity can be converted to moisture concentration by calculating the saturation pressure of the water vapor (p_{ws}) using the Goff-Gratch equation:
log₁₀(p_{ws})=7.90(373.16/(T−1))+5.03 log₁₀(373.16/T)−1.38×10⁻⁷((10^{11.34(1-T/373.16})−1)+8.13×10⁻³((10^{-3.49(373.16/(T-1)})−1)+log₁₀(1013.25)

(where T is in [K] and p_{ws} is in [hPa])

The partial pressure of the water vapor (p_{w}) can be calculated by multiplying the relative humidity (R.H.) by (p_{ws},) since:
R.H.=p_{w}/p_{ws}

As an ideal gas, the moisture concentration can be estimated from the calculated (P_{w}) with the following equation:
ppm(v/v)=(p_{w}/pₜ)×10⁶ (where pₜ is the total pressure)

### EXAMPLE 4

The purpose of the experiment was to determine the moisture output of the vaporizer when the purge gas flow rate was between 80 and 120 standard liters per minute (slm). Pressure and temperature were altered to modify the moisture output. The pressure and temperature drop across the system were also monitored during the experiment.

FIG. 14 illustrates a schematic a test manifold that include two moisturizers in parallel. A vessel was filled with de-ionized water and pressurized with gas to provide liquid pressures greater than 18 psig. First, the vessel was filled with water while the vent valve was open. Next, the vent valve is closed and the vessel was pressurized with purified nitrogen to 59 psig. A Parker Pressure Regulator was used to control the water pressure upstream of the moisturizers (pHasor® II Membrane Contactor available from Entegris Inc.) to at least 10 psig above the gas inlet pressure. An Entegris Pressure Transducer was used to measure the pressure downstream of this regulator. The water flow was through both pHasor® IIs. An Entegris Metering Valve was used to maintain the flow rate of the water to 100 milliliter per hour. A Millipore Pressure Gauge was used to monitor the gas pressure upstream of the system. The nitrogen upstream of both pHasors was purified with an Aeronex SS-500KF-I-4R purifier. Two 100 slm Porter Mass Flow Controller (MFC) were used to maintain the flow rate of house nitrogen through the lumen side of the pHasor® IIs. A pressure gauge and thermocouple were used to monitor the gas pressure and temperature upstream of the pHasor® IIs. Pressure gauges were used to measure the pressure of the water upstream and downstream of the pHasor® IIs. The pHasor® IIs were heated at 25° C. and 60° C. during this test. A Mykrolis Wafergard II was placed within the test manifold as a trap to remove any water droplets match its position in the Dual pHasor CHS. A Vaisala Moisture Probe was used to measure the relative humidity and temperature downstream of the moisturizers. An AP Tech backpressure regulator was used to maintain the pressure downstream of the moisturizers.

Initial relative humidity data gathered at with both pHasor® IIs heated to 25° C. and 60° C. respectively showed that the relative humidity increases with an increase in gas inlet pressure or temperature of the pHasor® IIs and that the relative humidity decreases with an increase in gas flow rate.

When the relative humidity data are converted to moisture concentrations, it is observed that the moisture concentration decreases when the gas pressure inlet to the moisturizers or vaporizers is increased. It was also observed that an increase in moisture concentration occurred with an increase in the temperature of the pHasor® IIs. The increase in temperature causes an increase in water evaporation and results in the higher water content.

It was also observed that the gas outlet temperature decreases with an increase in gas flow rate. Without wishing to be bound by theory, the cooling of the gas at higher flow rate may be due to evaporative cooling of the liquid.

It was discovered that by adjusting the temperature of the moisturizers, it was possible to offset the decrease in moisture concentration from the contactors with increasing gas flow rate. The gas outlet temperature was kept at 22.4° C. with the gas flow rate at 40, 80, and 120 slm. This temperature was maintained by changing the temperature of the pHasor® IIs by using an Omega Silicone heater. Furthermore, the pressure of liquid on the shell side was kept at 10 psig above the gas pressure on the lumen side. As shown in FIG. 15, the results of this test show that cooling normally caused by increased gas flow rate (for example FIG. 13(B)) can be offset by controlling the temperature of the vaporizers, in this case by heating the vaporizers, to maintain a relatively constant water vapor concentraion in the purge gas mixture independent of gas flow rate.

### EXAMPLE 5

This example illustrates generation of a purge gas mixture at flow rates greater than 100 slpm with liquid permeation through one or more hollow fiber vaporizers connected in parallel.

A manifold similar to that illustrated in FIG. 14 was used. As illustrated in FIG. 14, a water trap was placed directly downstream of the two pHasors® (vaporizers).

Set operational conditions for the tests, included a lumen side gas flow of nitrogen of about 120 slm at a source pressure of 100 psig (6.89 barg). System inlet pressure (upstream of check valves not shown) was about 40 psig (2.76 barg) and the gas pressure upstream of pHasor moisturizers was 16 psig (1.10 barg). The gas pressure outlet from the moisturizers was 7 psig (0.48 barg)

The operating conditions for the moisture for the liquid, which was on the shell side of the moisturizer, included an ultra pure source of water at a flow of 300 ml/hr from a source at 44 psig (3.03 barg) and liquid inlet pressure to the vaporizer of 35 psig (2.41 barg). Test time was about 2 hours.

The temperature of the contactors was maintained using an Omega Silicone heater.

TABLE 7
High flow moisturizer test conditions and generated relative
humidity.

| | | Water | Gas | | | |
|---|---|---|---|---|---|---|
| | Contactor | temp | temp | | Relative | Trap |
| | temp | inlet | inlet | Gas temp | humidity | volume |
| | (° C.) | (° C.) | (° C.) | outlet (° C.) | (%) | (ml) |
| Test 1 | 25 | 23.5 | 24 | 18.7 | 57.9 | 0 |
| Test 2 | 60 | 22.4 | 22.0 | 20.3 | 73.8 | 10 |
| Test 3 | 77 | 21.6 | 21.7 | 21.6 | 74.2 | 30 |

The results show that one or more contactors can be connected together to generate a vapor in the purge gas. The relative humidity of moisture in the purge gas mixture could be controlled to about 0.1% or better at a constant purge gas flow rate, pressure, and system temperature.

While this invention has been particularly shown and described with references to preferred embodiments thereof, it will be understood by those skilled in the art that various changes in form and details may be made therein without departing from the scope of the invention encompassed by the appended claims. For example, the vaporizer system could be used for producing controlled humidity comprising environment for eliminating static charge in a metal etching or other process.

What is claimed is:

1. An apparatus comprising:
a gas inlet in fluid communication with one or more regenerable purifiers having a gas inlet in fluid communication with a source gas and a purge gas outlet in fluid communication with purge gas inlet of a vaporizer, said purifiers remove contaminants from a gas inlet to the purifiers to form a purge gas;
said vaporizer comprising a housing and one or more microporous hollow fiber membranes, said housing comprising a purge gas inlet and a purge gas mixture outlet in fluid communication with a first side of the microporous hollow fibers, and said housing comprising a vaporizable liquid inlet and vaporizable liquid outlet in fluid communication with a second side of said microporous hollow fibers, said microporous hollow fiber membranes treated to remove contaminants that degrade the optical properties of optical components in a lithographic projection system, said microporous hollow fibers resistant to liquid intrusion by a vaporizable liquid;
a temperature regulation system that maintains the temperature of the vaporizer, the purge gas mixture outlet, or a combination of these within one or more setpoint ranges; and
a pressure regulation system that maintains the pressure of the vaporizable liquid and purge gas to prevent the formation of purge gas bubbles in the vaporizable liquid in the microporous hollow fibers.

2. The apparatus of claim 1 further wherein the temperature regulation system further a temperature controller, a heater, chiller, or a combination of these.

3. The apparatus of claim 1 wherein the pressure regulation system comprises a pressure controller and a back pressure regulator

4. The apparatus of claim 1 where the pressure regulation system maintains the vaporizable liquid pressure about 5 psi or more above the purge gas pressure.

5. The apparatus of claim 1 wherein the temperature regulation system maintains the temperature of the purge gas mixture outlet above the condensation point of the vapor.

6. The apparatus of claim 1 wherein the temperature regulation system maintains the temperature of the purge gas mixture independent of purge gas flow rate.

7. The apparatus of claim 1 further comprising a purge gas outlet in fluid communication with the purge gas mixture outlet.

8. The apparatus of claim 1 further comprising a liquid trap.

9. The apparatus of claim 1 comprising one or more vaporizers.

10. The apparatus of claim 1 where the purge gas mixture has less than 1 part per billion of contaminants that degrade the optical properties of optical components in a lithographic projection system.

11. A composition comprising: a purge gas mixture with a flow of greater than 20 slpm, said purge gas comprising less than 1 ppb contaminants that degrade the optical properties of optical components in a lithographic projection system, said purge gas mixture contains greater than about 20% of the vapor that saturates the purge gas, said vapor maintains or enhance the activity of chemicals used in a lithographic process.

12. A method comprising:
controlling the temperature of a vaporizer, a purge gas inlet to the vaporizer, or a combination of these within one or more setpoint ranges with a temperature regulation system;
controlling the pressure of a vaporizable liquid and a purge gas separated by one or more microporous hollow fibers in the vaporizer to reduce the formation of purge gas bubbles in the vaporizable liquid in the microporous hollow fibers with a pressure regulation system; and
contacting a purge gas with the vaporizable liquid in the vaporizer, said vaporizer comprising a housing and the one or more microporous hollow fiber membranes, said housing comprising a purge gas inlet and a purge gas mixture outlet in fluid communication with a first side of the one or more microporous hollow fibers, said housing comprising a vaporizable liquid inlet and vaporizable liquid outlet in fluid communication with a second side of said microporous hollow fibers, said microporous hollow fiber membranes treated to remove vaporizable contaminants that degrade the optical properties of optical components in a lithographic projection system and said microporous hollow fibers resistant to liquid intrusion by a vaporizable liquid.

13. The method of claim 12 where the pressure regulation system maintains the vaporizable liquid pressure about 5 psi or more above the purge gas pressure.

14. The method of claim 12 wherein the temperature regulation system maintains the temperature of the purge gas mixture outlet above the condensation point of the vapor.

15. The method of claim 12 wherein the temperature regulation system maintains the temperature of the purge gas mixture independent of purge gas flow rate.

16. The method of claim 12 further comprising the act of mixing purge gas with the purge gas mixture from the purge gas mixture outlet of the vaporizer.

17. The method of claim 12 further comprising the act of passing said purge gas mixture through a liquid trap and removing liquid.

18. The method of claim 12 further comprising the act of feeding the vaporizer with vaporizable liquid, the vaporizable liquid flowing in a re-circulation loop.

19. The method of claim 12 where the purge gas mixture has less than 1 part per billion of impurities.

20. The method of claim 12 where the vaporizable liquid generates a purge gas mixture that comprises a vapor that is utilized in a lithography process.
